(19) United States
(12) Patent Application Publication
(10) Pub. No.: US 2010/0140213 A1
(43) Pub. Date: Jun. 10, 2010

(54) APPARATUS FOR MANUFACTURING CARBON NANO TUBES AND METHOD OF SORTING CARBON NANO TUBES

(76) Inventors: Makoto MIZUKAMI, Kawasaki-shi (JP); Kiyohito NISHIHARA, Yokohama-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/618,039

(22) Filed: Nov. 13, 2009

(30) Foreign Application Priority Data
Dec. 10, 2008 (JP) 2008-314757

(51) Int. Cl. B44C 1/22; B05D 3/00; B03C 1/00

(52) U.S. Cl. 216/22; 427/561; 427/550; 209/214; 209/212; 209/231; 977/742; 977/842

(57) ABSTRACT

An apparatus for manufacturing carbon nano tubes of an aspect of the present invention including an introducing unit commonly introducing a first carbon nano tube having first magnetic characteristics and a second carbon nano tube having second magnetic characteristics different from the first magnetic characteristics, first and second collecting units collecting the first and second carbon nano tubes, respectively, a transport unit transporting the first and second carbon nano tubes from the introducing unit to the first and second collecting units, and at least one of a magnetic field generating unit which is provided adjacent to the transport unit and applies a magnetic field to the first and second carbon nano tubes, wherein the first carbon nano tube and the second carbon nano tube are sorted by the magnetic field generating unit.

### CROSS-REFERENCE TO RELATED APPLICATIONS

This application is based upon and claims the benefit of priority from prior Japanese Patent Application No. 2008-314757, filed Dec. 10, 2008, the entire contents of which are incorporated herein by reference.

### BACKGROUND OF THE INVENTION

1. Field of the Invention

The present invention relates to an apparatus for manufacturing carbon nano tubes and a method of sorting carbon nano tubes, and more particularly, to an apparatus and method for sorting carbon nano tubes according to their characteristics.

2. Description of the Related Art

A carbon nano tube is a cylindrical member obtained by rolling one graphite sheet. The carbon nano tube has a very small diameter in the range of about 1 nm to several ten nanometers, and has a stable structure. The carbon nano tube has attracted as a material for a more microscopic, nano-sized electronic device that exceeds the limitation of microfabrication by photolithography. In addition, in recent years, it has been suggested that the carbon nano tube is likely to exhibit ballistic conduction. Therefore, it is expected that the carbon nano tube will be used as a material forming a transistor that can be operated at a high speed.

In order to manufacture electronic devices, such as transistors, using the carbon nano tubes, it is necessary to set the electronic characteristics of the carbon nano tubes, particularly the band gap thereof, to a predetermined value.

However, the band gap of the carbon nano tubes, which determines the electronic characteristics, varies depending on the geometric structure, such as chirality, diameter, and length, and the carbon nano tubes have a metallic property or a semiconductor property.

In recent years, as a method of synthesizing the carbon nano tubes, various methods, such as a hydrocarbon catalyst decomposition method, have been known. However, it is difficult to align the geometric structure in a synthesis stage. Therefore, even when the carbon nano tubes are synthesized under the same conditions, generally, there is a variation in the characteristics of the carbon nano tubes.

For example, Japanese PCT National Publication No. 2005-532915 discloses a technique for covering the surfaces of a plurality of carbon nano tubes with a metal layer. This technique allows all the carbon nano tubes covered by the metal layer to have metallic properties. In this case, however, the characteristic of a semiconductor carbon nano tube is also changed to a metallic property. As a result, it is difficult to use the semiconductor property of the carbon nano tube.

Further, in recent years, as a method of manufacturing a transistor using the carbon nano tubes, a technique called “Constructive Destruction” has been used to selectively acquire the carbon nano tube having a semiconductor property required for a transistor. In this method, a plurality of carbon nano tubes are arranged in parallel to each other on a silicon substrate, and a voltage is applied to each of the carbon nano tubes. When the voltage is applied, only the metallic carbon nano tubes are selectively burned off and only the semiconductor carbon nano tubes remain on the substrate. In this case however, since the metallic carbon nano tubes do not remain, the metallic carbon nano tubes cannot be used for other devices.

The above-mentioned methods are used to sort the carbon nano tubes according to their characteristics. However, in order to put the carbon nano tubes to practical use, it is necessary to readily and effectively specify the characteristics of the carbon nano tubes. In addition, it is necessary to effectively use the carbon nano tubes having different characteristics depending on the intended use, and prevent a variation in the characteristics of devices using the carbon nano tubes.

### BRIEF SUMMARY OF THE INVENTION

An apparatus for manufacturing carbon nano tubes of an aspect of the present invention comprising: an introducing unit commonly introducing a first carbon nano tube having first magnetic characteristics and a second carbon nano tube having second magnetic characteristics different from the first magnetic characteristics; first and second collecting units collecting the first and second carbon nano tubes, respectively; a transport unit transporting the first and second carbon nano tubes from the introducing unit to the first and second collecting units; and at least one of a magnetic field generating unit which is provided adjacent to the transport unit and applies a magnetic field to the first and second carbon nano tubes; wherein the first carbon nano tube and the second carbon nano tube are sorted by the magnetic field generating unit.

A method of sorting carbon nano tubes of an aspect of the present invention comprising: commonly introducing a first carbon nano tube having first magnetic characteristics and a second carbon nano tube having second magnetic characteristics; applying a magnetic field to the first and second carbon nano tubes to sort out the first carbon nano tube and the second carbon nano tube using interaction between the first magnetic characteristics and the magnetic field; and collecting the sorted out first and second carbon nano tubes into different collecting units.

A method of sorting carbon nano tubes of an aspect of the present invention comprising: forming a first carbon nano tube having first magnetic characteristics and a second carbon nano tube having second magnetic characteristics on one substrate; and applying a magnetic field to the first and second carbon nano tubes such that the first carbon nano tube is selectively separated from the substrate and the second carbon nano tube remains on the substrate by interaction between the magnetic field and the first magnetic characteristics.

### BRIEF DESCRIPTION OF THE SEVERAL VIEWS OF THE DRAWING

FIG. 1 is schematic diagram illustrating embodiments of the invention;

FIG. 2 is schematic diagram illustrating embodiments of the invention;

FIG. 3 is a birds-eye view illustrating an apparatus for manufacturing carbon nano tubes according to a first embodiment;

FIG. 4A is a plan view illustrating the apparatus for manufacturing the carbon nano tubes according to the first embodiment;

FIG. 4B is a cross-sectional view illustrating the apparatus for manufacturing the carbon nano tubes according to the first embodiment;

FIG. 5 is schematic diagram illustrating a method of sorting carbon nano tubes;

FIG. 6 is a schematic diagram illustrating the method of sorting carbon nano tubes;

FIG. 7 is a schematic diagram illustrating the method of sorting carbon nano tubes;

FIG. 8 is a birds-eye view illustrating an apparatus for manufacturing carbon nano tubes according to a second embodiment;

FIG. 9 is a cross-sectional view illustrating the apparatus for manufacturing the carbon nano tubes according to the second embodiment;

FIG. 10 is a schematic diagram illustrating a third embodiment;

FIG. 11 is a schematic diagram illustrating the third embodiment;

FIG. 12 is a cross-sectional view illustrating an apparatus and method for sorting carbon nano tubes according to the third embodiment;

FIG. 13A is a diagram illustrating an example of an apparatus for manufacturing carbon nano tubes according to a fourth embodiment;

FIG. 13B is a diagram illustrating an example of the apparatus for manufacturing carbon nano tubes according to the fourth embodiment;

FIG. 14A is a diagram illustrating an example of the apparatus for manufacturing carbon nano tubes according to the fourth embodiment;

FIG. 14B is a diagram illustrating an example of the apparatus for manufacturing carbon nano tubes according to the fourth embodiment;

FIG. 15 is diagrams illustrating a method of sorting carbon nano tubes according to the fourth embodiment;

FIGS. 16A and 16B are diagrams illustrating an example of an apparatus for manufacturing carbon nano tubes according to a fifth embodiment;

FIG. 17 is a schematic diagram illustrating a sixth embodiment;

FIG. 18A is a schematic diagram illustrating the sixth embodiment;

FIG. 18B is a schematic diagram illustrating the sixth embodiment;

FIG. 19 is a diagram illustrating an application;

FIG. 20 is a diagram illustrating an application;

FIG. 21 is a diagram illustrating an application;

FIG. 22 is diagram illustrating a method of manufacturing carbon nano tubes;

FIG. 23 is a diagram illustrating a method of manufacturing carbon nano tubes;

FIG. 24 is diagram illustrating a method of manufacturing carbon nano tubes;

FIG. 25 is diagram illustrating a method of manufacturing carbon nano tubes;

FIG. 26 is diagram illustrating a method of manufacturing carbon nano tubes;

FIG. 27 is diagram illustrating a method of manufacturing carbon nano tubes;

FIG. 28 is diagram illustrating the structure and operation of a switching element;

FIG. 29 is diagram illustrating the structure of a transistor;

FIG. 30A is a process diagram illustrating a method of manufacturing a transistor;

FIG. 30B is a process diagram illustrating the method of manufacturing a transistor;

FIG. 30C is a process diagram illustrating the method of manufacturing a transistor;

FIG. 30D is a process diagram illustrating the method of manufacturing a transistor;

FIG. 30E is a process diagram illustrating the method of manufacturing a transistor;

FIG. 30F is a process diagram illustrating the method of manufacturing a transistor;

FIG. 31A is diagram illustrating the structure of interconnection;

FIG. 31B is diagram illustrating the structure of interconnection;

FIG. 32A is a process diagram illustrating a method of manufacturing the interconnection;

FIG. 32B is a process diagram illustrating the method of manufacturing the interconnection; and

FIG. 33 is a diagram illustrating the structure of an emitter element.

### DETAILED DESCRIPTION OF THE INVENTION

Hereinafter, exemplary embodiments of the invention will be described in detail with reference to the accompanying drawings.

[Outline]

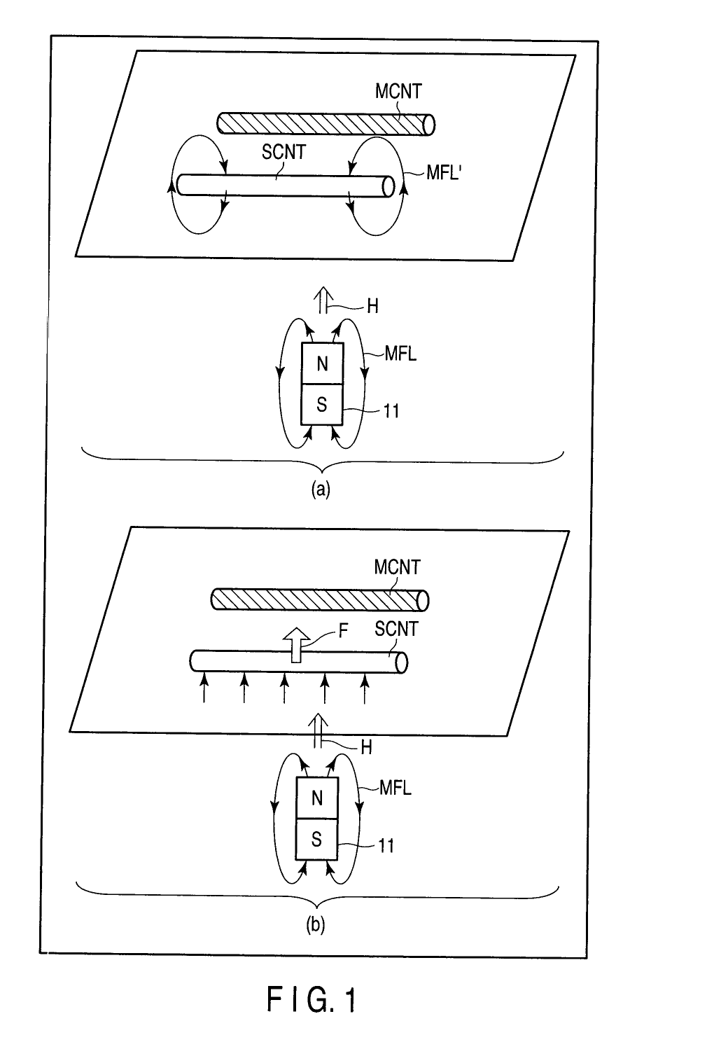

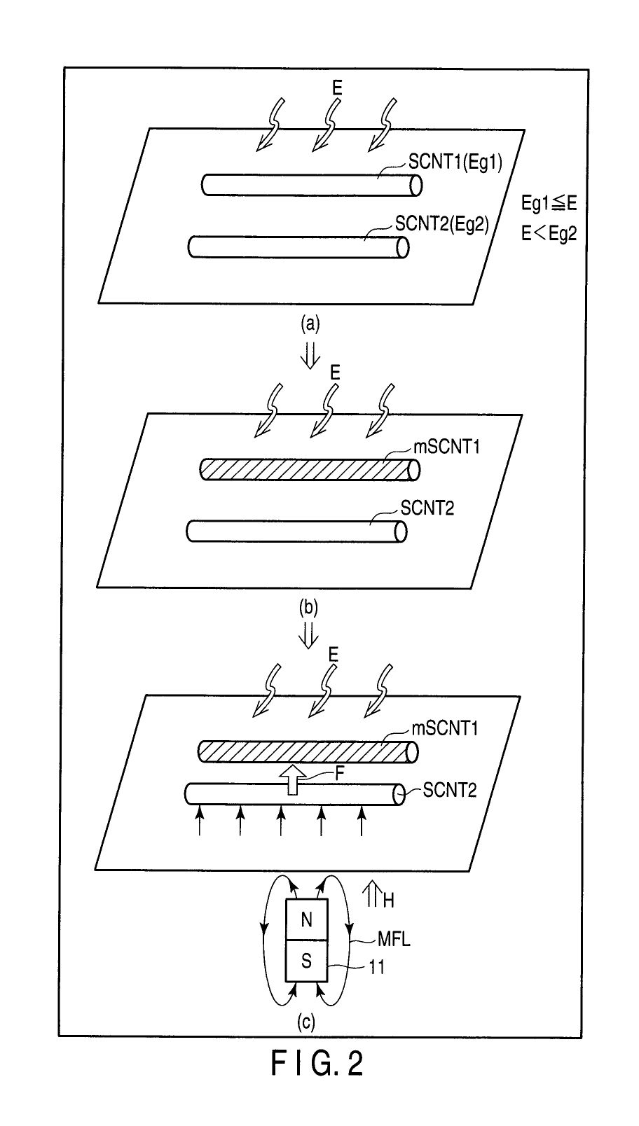

The outline of the exemplary embodiments of the invention will be described with reference to FIGS. 1 and 2.

(1) Characteristics of Carbon Nano Tube

First, characteristics of a carbon nano tube will be described.

In general, a material having a six-membered ring structure, such as graphite or a carbon nano tube, has diamagnetic properties (first magnetic characteristics) in which it is magnetized in a direction opposite to the magnetic field by diamagnetic orientation.

However, carbon nano tubes having different characteristics, such as different band structures, are formed even under the same conditions since differences in chirality of single-wall/multi-wall structure are generated when processes of forming the carbon nano tubes differ from one another. Chirality refers to the direction of the rotation of a graphene sheet forming a carbon nano tube.

In this way, carbon nano tubes having a metallic property (hereinafter, referred to as metallic carbon nano tubes) and carbon nano tubes having a semiconductor property (hereinafter, referred to as semiconductor carbon nano tubes) are formed on the same substrate under the same conditions.

The band structure of the metallic carbon nano tube is the same as that of metal, in which the valence band is directly contacted with the conduction band.

The band structure of the semiconductor carbon nano tube is the same as that of a semiconductor, in which there is a forbidden band (band gap) between the valence band and the conduction band. A carbon nano tube has a band gap in the range of about 0 eV to 2.5 eV. A carbon nano tube having a band gap of 0 eV is the metallic carbon nano tube.

There are few free electrons in the conduction band of the semiconductor carbon nano tube and there are a large number of free electrons in the conduction band of the metallic carbon nano tube, due to the difference in the band structures. It may be estimated that the number of charged electrons in the conduction band of the metallic carbon nano tube is substantially equal to the number of carbon atoms in the carbon nano tube. The reason for this is as follows. Since carbon (C) in the carbon nano tube forms a sp3 hybrid orbital, three bonds among four bonds are used for covalent bonding with adjacent carbon atoms, and one bond remains as an unpaired electron. The unpaired electron serves as the free electron.

As such, since there are a large number of free electrons in the conduction band of the metallic carbon nano tube, the free electrons existing in the surface of the metallic carbon nano tube cause the metallic carbon nano tube to show Pauli paramagnetism (second magnetic characteristics). Therefore, the metallic carbon nano tube has a positive magnetic susceptibility.

Similarly to the carbon nano tube, when a sufficient number of free electrons exist in the conduction band of graphite composed of a graphene sheet, such graphite has a Pauli paramagnetic coefficient of 0.35×10⁻⁶ to 0.7×10⁻⁶ [emu/g] (see, for example, V. Yu. Osipov, pp. 1225-1234, Carbon, 44 (2006)).

On the other hand, as described above, the semiconductor carbon nano tube shows diamagnetic characteristics (first magnetic characteristics), and has a negative magnetic susceptibility. The semiconductor carbon nano tube has a diamagnetic coefficient of about −5×10⁻⁶ [emu/g] at room temperature (see, for example, O. Chauvet, Phys. Rev., B52, R6963 (1995)). When a magnetic field is applied, the spins of electrons in a diamagnetic material are aligned in a direction in which the magnetic flux density of the magnetic field is reduced, and the spins of the electrons in a paramagnetic material are aligned with the direction of the magnetic field. The direction in which the magnetic flux density is reduced refers to a direction in which magnets having the same magnetic pole repel each other.

As such, the diamagnetic semiconductor carbon nano tube receives a repulsive force with respect to the direction of the magnetic field applied, unlike the paramagnetic metallic carbon nano tube.

In addition, the semiconductor carbon nano tube has a band gap, similarly to a typical semiconductor material. The band gap of the semiconductor carbon nano tube is larger than 0 eV and equal to or smaller than about 2.5 eV. The semiconductor carbon nano tubes have different band gaps due to difference in the chirality or the single-wall/multi-wall structures similarly to the difference between the metallic carbon nano tube and the semiconductor carbon nano tubes.

Similarly to a typical semiconductor, when light or thermal energy corresponding to the band gap of the semiconductor carbon nano tube is applied to the semiconductor carbon nano tube, free electrons in the valence band are excited, and the free electrons transit to the conduction band.

(2) Sorting of Carbon Nano Tubes

As described above, of the carbon nano tubes, the semiconductor carbon nano tube and the metallic carbon nano tube have different magnetic characteristics.

In the following embodiments and applications, apparatuses and methods will be described which sort the semiconductor carbon nano tubes and the metallic carbon nano tubes based on whether a repulsive force is generated when a magnetic field is applied to the semiconductor carbon nano tubes (diamagnetic) and the metallic carbon nano tubes (paramagnetic due to surface electrons).

The principle of sorting the semiconductor carbon nano tubes and the metallic carbon nano tubes will be described with reference to FIG. 1. FIG. 1 is schematic diagram illustrating the principle of sorting the carbon nano tubes.

A semiconductor carbon nano tube SCNT has a diamagnetic property. On the other hand, a metallic carbon nano tube MCNT has a paramagnetic property due to the free electrons in the surface thereof.

As shown in the (a) of FIG. 1, when a magnetic body (for example, a magnet) 11 approaches the semiconductor and metallic carbon nano tubes SCNT and MCNT, the semiconductor carbon nano tube SCNT is magnetized in a direction opposite to the direction of the magnetic field of the magnetic body 11 due to its magnetic characteristics, that is, its diamagnetic property (negative magnetic susceptibility). Therefore, magnetic field lines MFL′ are generated from the semiconductor carbon nano tube in a direction opposite to the direction of the magnetic field lines (magnetic field) MFL of the magnetic body.

As shown in the (b) of FIG. 1, when the magnetic body 11 approaches the semiconductor and metallic carbon nano tubes, the interaction between the magnetic field lines MFL and MFL′ of the magnetic body 11 and the semiconductor carbon nano tube SCNT is strengthened. In this way, a repulsive force F caused by the diamagnetism of the semiconductor carbon nano tube SCNT is applied to the semiconductor carbon nano tube SCNT.

On the other hand, since the metallic carbon nano tube MCNT has paramagnetic characteristics (positive magnetic susceptibility), the metallic carbon nano tube MCNT is weakly magnetized in the same direction as that of the magnetic field lines (magnetic field) of the magnetic body 11. Therefore, there is almost no interaction between the metallic carbon nano tube MCNT and the magnetic body 11.

As such, the repulsive force is generated from the diamagnetic semiconductor carbon nano tube SCNT, but no repulsive force (and no attraction) is generated from the paramagnetic metallic carbon nano tube MCNT.

The semiconductor carbon nano tube SCNT is accelerated by the repulsive force F, and the semiconductor carbon nano tube SCNT is moved in the direction of the acceleration.

As described above, in the embodiments of the invention, the semiconductor carbon nano tubes SCNT are selectively extracted from a group of carbon nano tubes including the semiconductor carbon nano tubes SCNT and the metallic carbon nano tubes MCNT, based on whether the repulsive force is generated due to the difference between the magnetic characteristics, thereby sorting the carbon nano tubes according to their characteristics.

Further, in the embodiments of the invention, a structure and method of sorting the semiconductor carbon nano tubes SCNT having different band gaps according to their band gaps will be described.

It has been known that, when thermal energy is applied or laser light is irradiated to a semiconductor material to apply energy having a predetermined level or higher to the semiconductor material, electrons in the valence band transit to the conduction band over the energy gap. In the embodiments of the invention, this phenomenon is used to sort the semiconductor carbon nano tubes SCNT1 and SCNT2 having different band gaps according to their band gaps.

As shown in the (a) of FIG. 2, light or thermal energy E is applied from the exterior to the semiconductor carbon nano tubes SCNT1 and SCNT2 having different band gaps Eg1 and Eg2. Here, the case in which the band gap Eg2 is larger than the band gap Eg1, and the external energy E is equal to or larger than the energy corresponding to the band gap Eg1 and smaller than energy corresponding to the band gap Eg2 will be described.

As shown in the (b) of FIG. 2, when the level of the energy E applied is equal to or higher than that of energy corresponding to the band gap Eg1 and is high enough to move electrons in the valence band to the conduction band, the semiconductor carbon nano tube SCNT1 having the band gap Eg1 shows a pseudo-metallic property. That is, the magnetic characteristic of a semiconductor carbon nano tube mSCNT1 in an excited state is temporarily changed into a paramagnetic property while electrons are being excited.

On the other hand, when the level of the energy E applied is lower than that of the energy corresponding to the band gap Eg2, electrons in the valence band of the semiconductor carbon nano tube SCNT2 having the band gap Eg2 do not transit to the conduction band. Therefore, the magnetic characteristics of the semiconductor carbon nano tube SCNT2 are maintained in a diamagnetic state even when external energy is applied.

As shown in the (c) of FIG. 2, with energy being applied from the outside, a magnetic field H is applied to the semiconductor carbon nano tube mSCNT1 in the excited state, which is temporarily paramagnetic, and the diamagnetic semiconductor carbon nano tube SCNT2, similarly to when the metallic carbon nano tube is discriminated from the semiconductor carbon nano tube. Therefore, the repulsive force F is generated from only the semiconductor carbon nano tube SCNT2, but no repulsive force is generated from the semiconductor carbon nano tube mSCNT1 in the excited state.

As such, when the magnetic field is applied with a common external energy E being applied to a plurality of carbon nano tubes, the semiconductor carbon nano tube SCNT2 having a band gap larger than the applied energy E may be extracted from a group of semiconductor carbon nano tubes (semiconductor carbon nano tubes in an excited state) having different band gaps.

Therefore, in the embodiments of the invention, the wavelength of light emitted from a light source or the amount of heat applied is controlled to apply energy corresponding to the band gap of the semiconductor carbon nano tube, thereby selectively sorting out the carbon nano tubes having an arbitrary band gap.

As described above, in the embodiments of the invention, it is possible to sort the carbon nano tubes having different band gaps, such as metallic and semiconductor carbon nano tubes, according to their characteristics based on the difference between the magnetic characteristics.

Accordingly, in the embodiments of the invention, it is not necessary to use a method of damaging one of the semiconductor and metallic carbon nano tubes, such as a method of electrically melting down the metallic carbon nano tubes in order to sort the characteristics of the carbon nano tubes.

Therefore, according to the embodiments of the invention, it is possible to readily and effectively sort the carbon nano tubes according to their characteristics. In addition, according to the embodiments of the invention, it is possible to use both the semiconductor and metallic carbon nano tubes formed on the same substrate.

### EMBODIMENTS

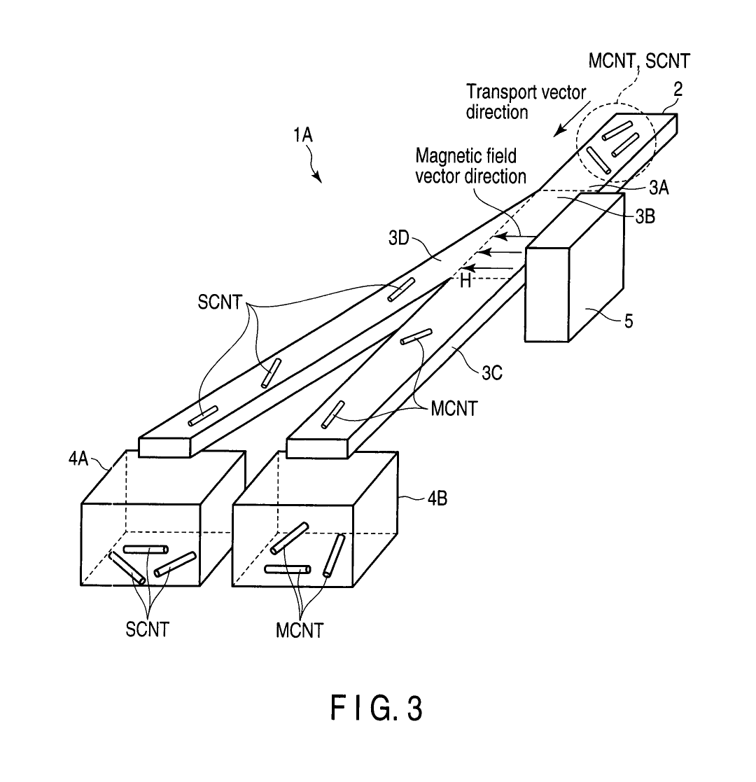

Hereinafter, exemplary embodiments of the invention will be described with reference to FIGS. 3 to 18B.

### (1) First Embodiment

Hereinafter, an apparatus for manufacturing carbon nano tubes, and an apparatus and method for sorting the carbon nano tubes according to their characteristics according to a first embodiment of the invention will be described with reference to FIGS. 3 to 7.

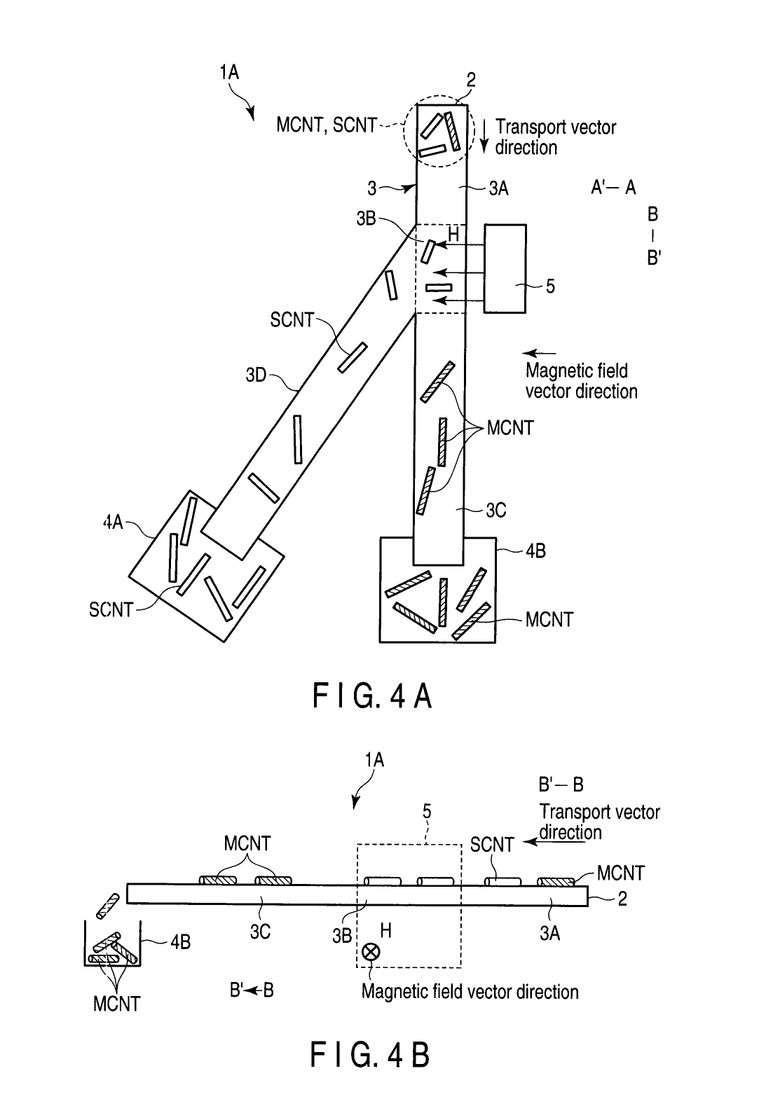

(a) Apparatus for sorting carbon nano tubes FIGS. 3, 4A and 4B illustrate an example of the structure of the apparatus for sorting the carbon nano tubes.

FIG. 3 is a birds-eye view of the apparatus for sorting the carbon nano tubes. FIG. 4A is a diagram illustrating a plan structure of the apparatus shown in FIG. 3. FIG. 4B is a cross-sectional view of the apparatus shown in FIG. 3 as viewed from the direction in which the magnetic field is applied. It is to be appreciated that FIGS. 3, 4A, and 4B illustrate main components of an apparatus 1A for sorting the carbon nano tubes according to this embodiment, and other components may be added to the structure shown in FIGS. 3, 4A, and 4B.

The apparatus 1A for sorting the carbon nano tubes shown in FIGS. 3, 4A, and 4B includes an introducing unit 2 that introduces a plurality of carbon nano tubes SCNT and MCNT, a transport unit 3 that transports the carbon nano tubes, first and second collecting units 4A and 4B that collect the carbon nano tubes having characteristics different from one another, and a magnetic field generating unit 5 that generates a magnetic field H to be applied to the plurality of carbon nano tubes SCNT and MCNT on the transport unit 3.

The plurality of carbon nano tubes SCNT and MCNT are introduced from the introducing unit 2 onto the transport unit 3. The carbon nano tubes SCNT and MCNT are formed using any one of synthesizing methods including a catalytic decomposition of hydrocarbon method, an arc discharge method, a laser abrasion method, and a plasma synthesis method. However, the method of synthesizing the carbon nano tubes SCNT and MCNT according to this embodiment is not limited thereto.

The plurality of formed carbon nano tubes SCNT and MCNT may have different structures. For example, the carbon nano tubes SCNT and MCNT may be different in the direction of the rotation of the graphene sheets (chiralities) and single wall/multi-wall structures.

The band gaps of the carbon nano tubes SCNT and MCNT are about 0 eV to 2.5 eV. The band gaps of the carbon nano tubes SCNT and MCNT vary due to the differences in the structures.

As such, even when the carbon nano tubes are formed on the same substrate under the same conditions, the structures and band gaps thereof are not uniform. Therefore, the carbon nano tubes SCNT and MCNT introduced into the apparatus 1A have different characteristics due to the structures and band gaps thereof, and the semiconductor carbon nano tubes SCNT and the metallic carbon nano tubes MCNT are mixed in the apparatus. It is to be noted that the band gap of the metallic carbon nano tube MCNT is 0 eV. In the first embodiment, for simplicity of explanation, it is assumed that the semiconductor carbon nano tube SCNT has a fixed band gap.

The transport unit 3 is, for example, a belt conveyer, and a stage on which the carbon nano tubes are loaded is moved along a certain direction. The transport unit 3 transports the loaded carbon nano tubes SCNT and MCNT from the introducing unit 2 to the collecting units 4A and 4B using the movable stage. In this embodiment, the force of the transport unit 3 for transporting the carbon nano tubes MCNT and SCNT is referred to as a transport vector. In the drawings, the transport vector is represented by “V”. The transport unit 3 has transport vector of a predetermined size, and transports the carbon nano tubes MCNT and SCNT based on the size of the transport vector.

The magnetic field generating unit 5 is provided adjacent to a region 3B of the transport unit 3. The magnetic field generating unit 5 generates the magnetic field H with predetermined intensity, and applies the magnetic field H to a plurality of carbon nano tubes MCNT and SCNT on the transport unit 3. For example, the magnetic field H is set in the direction from A to A′ in the drawings. For example, an electromagnetic coil or a magnet is used as the magnetic field generating unit 5, and the structure thereof will be described later.

Next, the structure of the transport unit 3 will be described in detail.

In the region 3B of the transport unit 3 arranged adjacent to the magnetic field generating unit 5, the magnetic field H generated by the magnetic field generating unit 5 is applied to a plurality of carbon nano tubes MCNT and SCNT. Hereinafter, the region 3B of the transport unit 3 is referred to as a magnetic field application region 3B.

In the magnetic field application region 3B, the transport unit 3 is branched in two directions to the first collecting unit 4A and to the second collecting unit 4B. Hereinafter, a portion 3D branched to the first collecting unit 4A is referred to as a first branch portion 3D, and a portion 3C branched to the second collecting unit 4B is referred to as a second branch portion 3C. In addition, in the transport unit 3, a portion 3A from the introducing unit 2 to the magnetic field application region 3B is referred to as a common portion 3A.

For example, the branch portion 3C and the common portion 3A extend in a straight line along the direction B-B′ from the introducing unit 2 to the second collecting unit 4B through the magnetic field application region 3B. The direction of the transport vector of the branch portion 3C is aligned with, for example, the direction of the transport vector from the common portion 3A to the magnetic field application region 3B. Therefore, the direction of the transport vector between the common portion 3A and the branch portion 3C is aligned with the direction B-B′.

The branch portion 3D extends from the magnetic field application region 3B to the collecting unit 4A obliquely with respect to the direction in which the common portion 3A and the branch portion 3C extend in the same plane. Therefore, the direction of the transport vector of the branch portion 3D is different from that of the transport vector (direction B-B′) between the common portion 3A and the branch portion 3C.

The transport vector in the common portion 3A and the magnetic field application region 3B, the transport vector in the first branch portion 3D, and the transport vector in the second branch portion 3C may have the same size or different sizes.

In the magnetic field application region 3B, a plurality of carbon nano tubes SCNT and MCNT transported through the common portion 3A are sorted into the semiconductor carbon nano tubes SCNT and the metallic carbon nano tubes MCNT by the interaction between the magnetic characteristics of the carbon nano tubes and the magnetic field H applied. The interaction between the carbon nano tubes SCNT, MCNT and the magnetic field H will be described in detail later.

The sorted out metallic carbon nano tubes MCNT are collected in the collecting unit 4B through the branch portion 3C. The sorted out semiconductor carbon nano tubes SCNT are collected in the collecting unit 4A through the branch portion 3D.

As such, the metallic carbon nano tubes MCNT and the semiconductor carbon nano tubes SCNT are collected into different collecting units 4A and 4B.

In this embodiment, the magnetic field H is applied to the metallic carbon nano tubes MCNT and the semiconductor carbon nano tubes SCNT in the magnetic field application region 3B. A repulsive force is generated between the magnetic field H and the diamagnetic semiconductor carbon nano tube SCNT. On the other hand, no repulsive force is generated between the paramagnetic metallic carbon nano tube MCNT and the magnetic field H.

When the repulsive force is applied to the semiconductor carbon nano tube SCNT, the semiconductor carbon nano tube SCNT is accelerated in a composite vector direction of the direction of the repulsive force (magnetic field) and the direction of the transport vector. As a result, the semiconductor carbon nano tube SCNT is ejected from the magnetic field application region 3B to the branch portion 3D and is then moved on the branch portion 3D.

On the other hand, since no repulsive force is generated from the metallic carbon nano tube MCNT, the metallic carbon nano tube MCNT is moved from the magnetic field application region 3B to the branch portion 3C by the transport vector.

Accordingly, it is possible to move the semiconductor and metallic carbon nano tubes SCNT and MCNT having different magnetic characteristics from the magnetic field application region 3B to different branch portions 3C and 3D using the magnetic field H.

It is preferable that the entire system of the apparatus be in, for example, a vacuum state. In this case, it is possible to reduce the semiconductor carbon nano tubes SCNT that are not ejected from the magnetic field application region 3B to the branch portion 3D due to collision with nitrogen molecules in air. As a result, it is possible to accurately sort the semiconductor and metallic carbon nano tubes SCNT and MCNT. In addition, it is preferable that the temperature of the entire system be controlled, for example, to a constant temperature.

As described above, in the first embodiment of the invention, it is possible to sort out the semiconductor carbon nano tubes and the metallic carbon nano tubes based on the difference in the characteristics of the semiconductor and metallic carbon nano tubes.

Therefore, according to this embodiment, it is possible to readily and effectively sort out the semiconductor carbon nano tubes and the metallic carbon nano tubes according to their characteristics.

In addition, according to this embodiment, it is possible to sort the metallic and semiconductor carbon nano tubes without adversely affecting the characteristics thereof. Therefore, it is possible to effectively use both the metallic carbon nano tubes and the semiconductor carbon nano tubes formed on the same substrate.

(b) Method of Sorting Carbon Nano Tubes

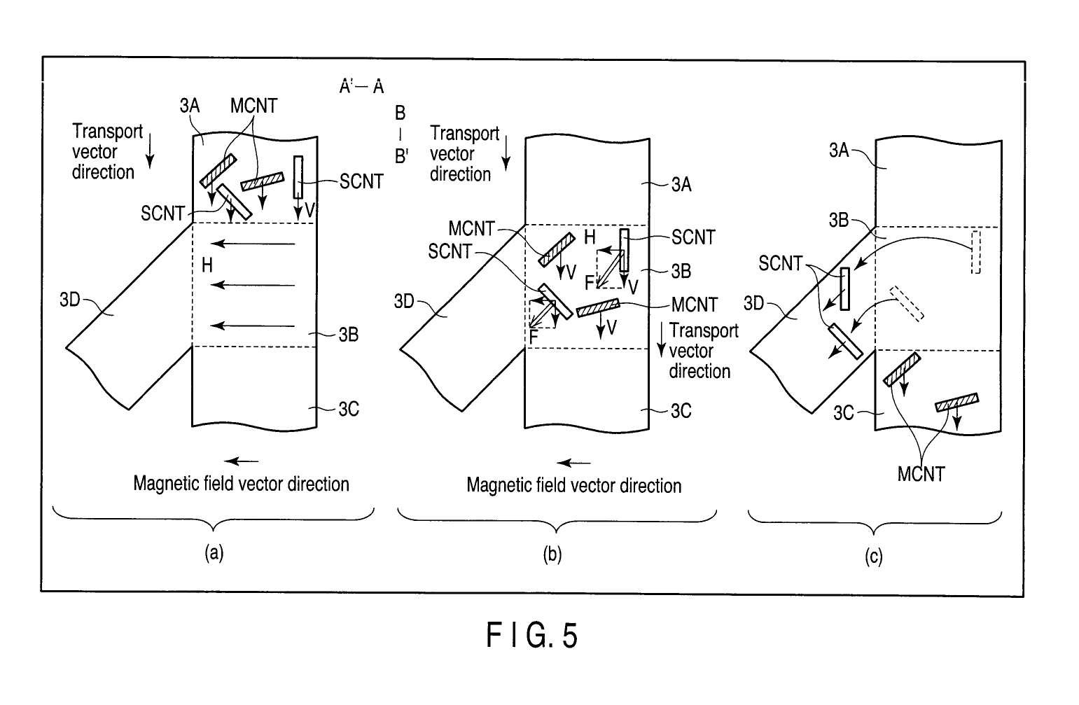

Next, a method of sorting carbon nano tubes according to the first embodiment of the invention will be described with reference to FIGS. 5 to 7. Here, a method of sorting carbon nano tubes using the apparatus 1A for sorting carbon nano tubes shown in FIGS. 4A and 4B will be described.

As shown in FIGS. 4A, 4B, and the (a) of FIG. 5, a plurality of carbon nano tubes MCNT and SCNT are introduced from the introducing unit 2 into the common portion 3A. The introduced carbon nano tubes MCNT and SCNT are not sorted according to their characteristics, but the metallic carbon nano tubes MCNT and the semiconductor carbon nano tubes SCNT are mixed. As described above, the difference in the characteristics of the carbon nano tubes SCNT and MCNT is caused by the difference in the chiralities or the single wall/multi-wall structures of the carbon nano tubes.

In the common portion 3A, the semiconductor carbon nano tubes SCNT and the metallic carbon nano tubes MCNT are transported by the transport vector.

As shown in the (b) of FIG. 5, the carbon nano tubes MCNT and SCNT are transported by the transport vector from the common portion 3A to the magnetic field application region 3B in the transport unit 3 (for example, a belt conveyer) in the direction of the transport vector (direction B-B′).

The magnetic field H generated by the magnetic field generating unit 5 is applied to the magnetic field application region 3B. Thus, the magnetic field H is applied to the carbon nano tubes MCNT and SCNT transported into the magnetic field application region 3B. In FIG. 5, the vector direction of the magnetic field H is aligned with the direction A-A′. However, the vector direction of the magnetic field H may be any direction intersecting the direction of the transport vector, and is not limited to the direction orthogonal the transport vector.

The semiconductor carbon nano tube SCNT has diamagnetic characteristics (first magnetic characteristics). Therefore, the repulsive force F is applied to the semiconductor carbon nano tube SCNT in the magnetic field application region 3B by the interaction between its magnetic characteristics and the magnetic field H.

In the magnetic field application region 3B, the metallic carbon nano tube MCNT has paramagnetic characteristics (second magnetic characteristics). Therefore, the repulsive force F is not applied to the metallic carbon nano tube MCNT, and the interaction between the magnetic field H and the magnetic characteristics of the metallic carbon nano tube MCNT is small. Accordingly, the metallic carbon nano tube MCNT is little affected by the magnetic field H.

The magnitude of the repulsive force F generated between the magnetic field H and the semiconductor carbon nano tube SCNT will be described.

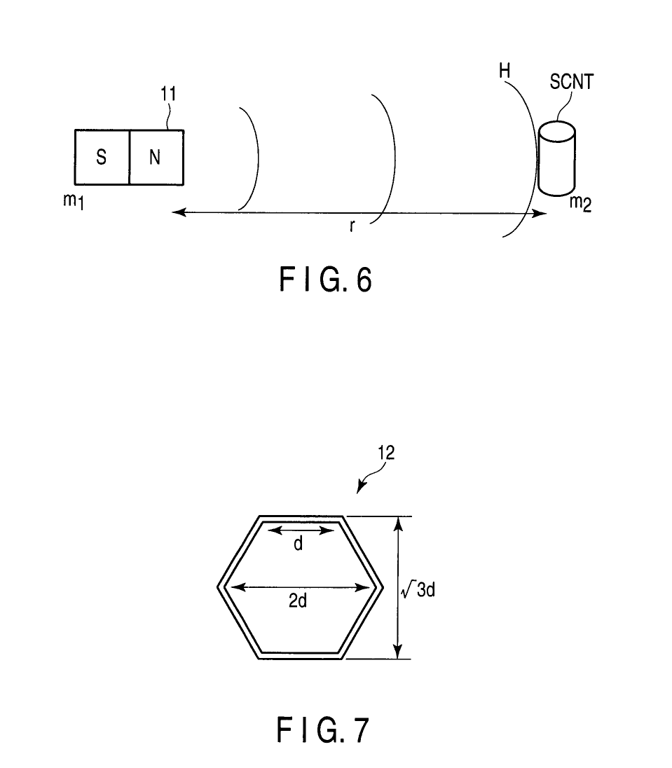

As shown in FIG. 6, a magnetic dipole 11, which is a magnetic field source, is spaced a distance r from the carbon nano tube SCNT. The magnetic dipole 11 has a magnetic moment m₁ and the semiconductor carbon nano tube SCNT has a magnetic moment m₂.

In this case, the intensity of the magnetic field H [A/m] generated by the magnetic dipole 11 having the magnetic moment m₁ at the distance r is represented by the following Expression (1):

$$H = \frac{- 1}{4 π {μ}_{0} {r}^{3}} [ {m}_{1} - \frac{3}{{r}^{2}} ( {m}_{1} r ) r cos θ ] \qquad ( 1 )$$

In the Expression 1, when θ=0°, the magnetic field H (the intensity of the magnetic field) is represented by the following Expression (2):

$$H = \frac{2 {m}_{1}}{4 π {μ}_{0} {r}^{3}} \qquad ( 2 )$$

The semiconductor carbon nano tube SCNT is magnetized by the magnetic field H generated by the magnetic dipole 11. When the magnetization of a carbon nano tube per unit volume is I and the volume of the carbon nano tube is V, the magnetic moment m₂ of the semiconductor carbon nano tube SCNT is represented by the following Expression (3):

m₂=I×V (3)

In addition, when the mass magnetic susceptibility is χ, the magnetization I of the semiconductor carbon nano tube SCNT per unit volume is represented by the following Expression 4:

I=H×χ (4)

The magnetic moment m₂ is represented by the following Expression (5) using the above-mentioned two expressions:

m₂=H×χ×V (5)

Mutual energy U applied to the semiconductor carbon nano tube SCNT by the magnetic field H generated by the magnetic moment m₁ of the magnetic dipole 11 is represented by the following Expression (6):

U=−m₂×H (6)

When θ=0° in the Expression 6, the force (repulsive force) F [N] applied to the semiconductor carbon nano tube by the magnetic field H of the magnetic dipole 11 is represented by the following Expression (7):

$$F = \frac{\partial }{\partial r} U = \frac{- 6}{4 π {μ}_{0} {r}^{4}} ( {m}_{1} {m}_{2} ) \qquad ( 7 )$$

In the Expression 2, for example, when the distance r is 1 [cm] and the magnetic moment m₁ of the magnetic dipole 11 is 2×10⁻⁷ [Wb·m], the magnetic field H is 2.4×10⁴ [A/m].

For example, when it is assumed that the diameter of the semiconductor carbon nano tube SCNT is 10 [nm], and the length of the semiconductor carbon nano tube SCNT is 100 [nm], the volume V of the semiconductor carbon nano tube SCNT is 7.7×10⁻²⁴ [m⁻³].

In addition, the size of a graphene sheet for forming the semiconductor carbon nano tube SCNT is 31.4 [nm]×100 [nm]. In a six-membered ring 12 shown in FIG. 7, the number of carbon atoms included in one six-membered ring is two, and the distance d between the carbon atoms having covalent bonding therebetween is 0.1397 [nm]. Accordingly, the graphene sheet having the above-mentioned size includes 80×300 carbon rings. Since the mass of one carbon atom is 2×10⁻²³ [g], the mass m_{SCNT} of the graphene sheet (semiconductor carbon nano tube SCNT) is 1×10⁻²¹ [g]. In addition, the mass magnetic susceptibility of the carbon nano tube is 5×10⁻⁶ [emu/g]. However, when the mass magnetic susceptibility is converted into volume magnetic susceptibility, the volume magnetic susceptibility is 1×10⁻¹¹ [H/m].

The magnetic moment m₂ of the semiconductor carbon nano tube SCNT at the distance r (=1 [cm]) is 1.9×10⁻³° [Wb·m] by the Expression 5. The magnetic moments m₁ and m₂ cause a force (repulsive force) F of 5×10⁻²³ [N] to be applied to the semiconductor carbon nano tube that is spaced the distance r from the magnetic dipole 11, based on the Expression 7. In addition, the acceleration a of the semiconductor carbon nano tube SCNT receiving the force F (=m_{SCNT}×a) is 0.05 [cm²/s] since the mass m_{SCNT} of the semiconductor carbon nano tube SCNT is 1×10⁻²¹ [g].

As such, the repulsive force F is applied to the semiconductor carbon nano tube SCNT by the magnetic field H, and the semiconductor carbon nano tube SCNT is accelerated and moved to the branch portion 3D.

However, the force (repulsive force) applied to the semiconductor carbon nano tube SCNT is just an example, and may vary depending on the shape (length and size) of the semiconductor carbon nano tube SCNT or the distance between the magnetic field source 11 (magnetic field generating unit 5) and the semiconductor carbon nano tube SCNT.

As shown in the (b) of FIG. 5, since the magnetic field application region 3B has the transport vector, the direction of the repulsive force (acceleration) F applied to the semiconductor carbon nano tube SCNT is aligned with a composite vector direction of the direction of the magnetic field vector and the direction of the transport vector.

Thus, as shown in the (c) of FIG. 5, the semiconductor carbon nano tube SCNT is moved in a direction different from the direction of the transport vector (direction A-A′ in the drawings) and is then ejected from the magnetic field application region 3B to the branch portion 3D. However, as described above, the intensity of the magnetic field H and the repulsive force F caused by the magnetic field H depend on the distance between the magnetic field generating unit 5 and the semiconductor carbon nano tube SCNT. Therefore, it is preferable that the width and length of the magnetic field application region 3B be appropriately set such that the semiconductor carbon nano tube SCNT is moved from the magnetic field generating unit 5 to the branch portion 3D by the magnetic field H.

On the other hand, since the metallic carbon nano tube MCNT is not affected by the interaction caused by the magnetic field H, the metallic carbon nano tube MCNT is transported from the magnetic field application region 3B to the branch portion 3C along the direction of the transport vector.

The semiconductor carbon nano tube SCNT is transported in the collecting unit 4A shown in FIGS. 4A and 4B by the transport vector of the branch portion 3D. The metallic carbon nano tube MCNT is transported in the collecting unit 4B by the transport vector of the branch portion 3C.

As described above, the semiconductor carbon nano tube SCNT and the metallic carbon nano tube MCNT are sorted out by the interaction between their different magnetic characteristics and the magnetic field H applied, and are then collected into the separated collecting units 4A and 4B, respectively.

As such, in the first embodiment of the invention, the semiconductor carbon nano tube SCNT and the metallic carbon nano tube MCNT are sorted out based on the difference in magnetic characteristics between the semiconductor carbon nano tube SCNT and the metallic carbon nano tube MCNT, that is, the difference between the diamagnetic semiconductor carbon nano tube SCNT and the paramagnetic metallic carbon nano tube MCNT.

More specifically, when the magnetic field H is applied from the outside to the carbon nano tubes SCNT and MCNT, the repulsive force is generated from the semiconductor carbon nano tube SCNT due to diamagnetism, and the semiconductor carbon nano tube SCNT is selectively extracted from a group of the semiconductor and metallic carbon nano tubes SCNT and MCNT.

In this embodiment, it is not necessary to individually examine the characteristics and structure of the carbon nano tubes, and it is possible to sort a plurality of carbon nano tubes simultaneously using a simple apparatus, such as the apparatus 1A (see FIGS. 3, 4A and 4B), according to their characteristics (for example, their band gaps).

Therefore, according to the method of sorting the carbon nano tubes according to this embodiment, it is possible to readily and effectively sort the carbon nano tubes according to the sizes of their band gaps.

Since this embodiment uses the unique characteristics of carbon nano tubes, it is not necessary to perform a specific process on the carbon nano tubes in order to sort the carbon nano tubes, and it is possible to sort the carbon nano tubes according to their characteristics without changing their states after being formed. In addition, a process adversely to affect the characteristics of a plurality of carbon nano tubes or a process to damage the carbon nano tubes with unnecessary characteristics is not performed, and it is possible to effectively use both the semiconductor carbon nano tube and the metallic carbon nano tube while maintaining their characteristics obtained during manufacture.

Therefore, according to the method of sorting the carbon nano tubes of this embodiment, it is possible to effectively use the carbon nano tubes with different characteristics for appropriate devices according to their characteristics.

### (2) Second Embodiment

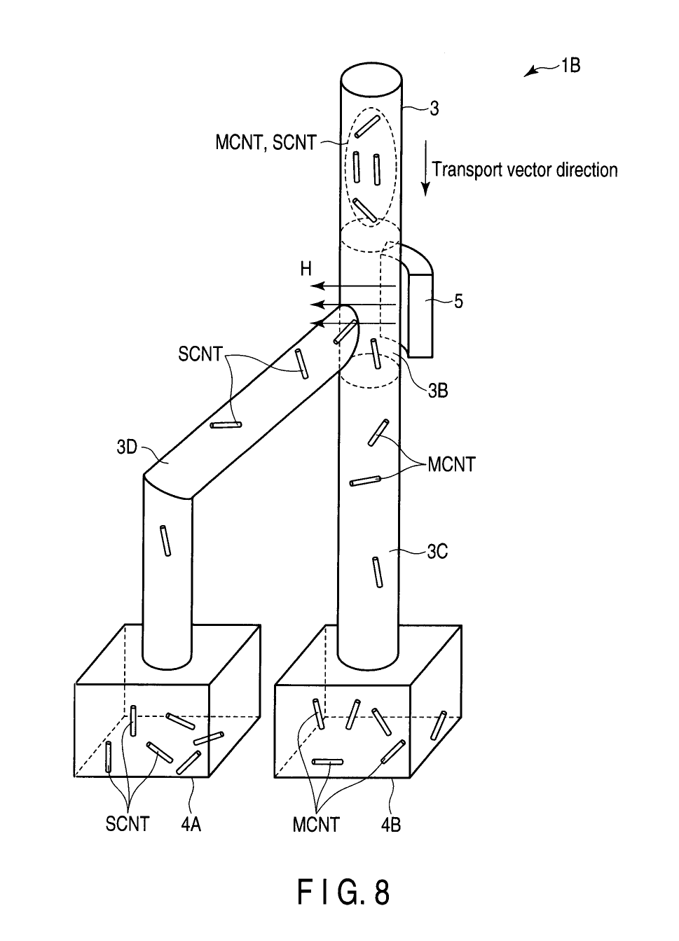

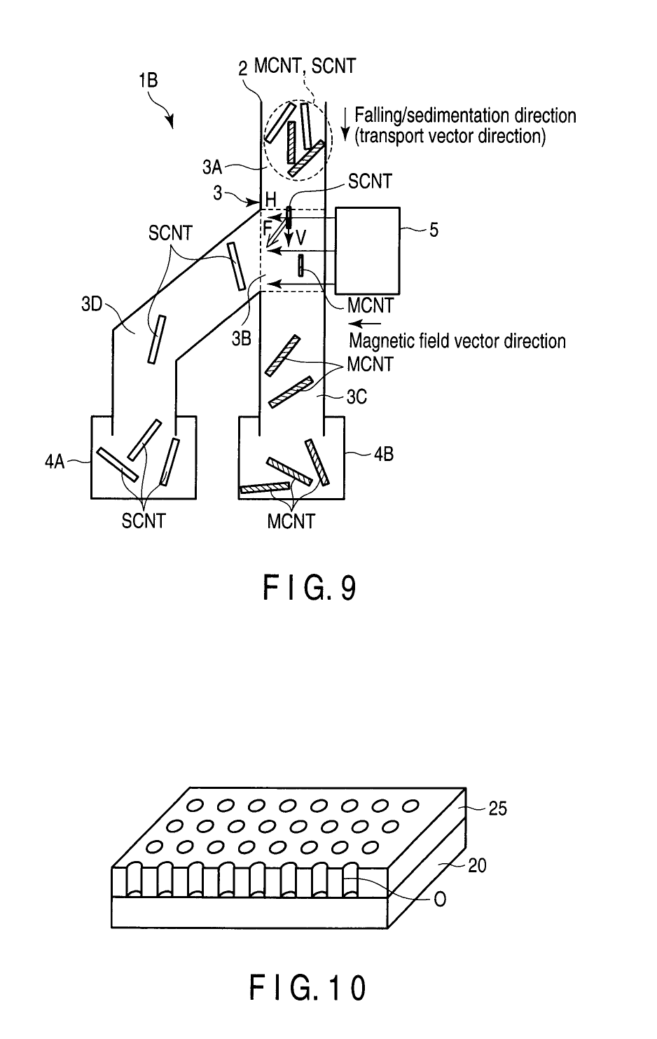

Next, an apparatus and method of sorting carbon nano tubes according to a second embodiment of the invention will be described with reference to FIGS. 8 and 9. Substantially the same members as those in the first embodiment are denoted by the same reference numerals, and a detailed description thereof will be made if necessary.

In the first embodiment, a plurality of carbon nano tubes SCNT and MCNT are loaded on the transport unit 3 having a certain transport vector, and are mechanically transported from the introducing unit 2 to the collecting units 4A and 4B through the magnetic field application region 3B of the transport unit 3.

In the second embodiment, an example of freely dropping a plurality of carbon nano tubes SCNT and MCNT in a vacuum, gas, or fluid to transport the carbon nano tubes from the introducing unit 2 to the collecting units 4A and 4B will be described.

FIGS. 8 and 9 are a birds-eye view and a cross-sectional view of the apparatus for sorting the carbon nano tubes according to the second embodiment of the invention, respectively. FIGS. 8 and 9 show main components of the apparatus for sorting the carbon nano tubes according to this embodiment, and it is appreciated that other components may be added to the structure of the apparatus.

The entire transport unit 3 is, for example, a cylindrical member that is arranged vertically to the ground. The inside of the cylindrical member forming the transport unit 3 is in a vacuum state, for example. Alternatively, the inside of the cylindrical member forming the transport unit 3 may be filled with a gas or liquid. Similarly to the first embodiment, the transport unit 3 includes a common portion 3A, a magnetic field application region 3B, and two branch portions 3C and 3D. In addition, a magnetic field generating unit 5 is provided adjacent to the magnetic field application region 3B. In the magnetic field application region 3B, a magnetic field H is applied to a plurality of carbon nano tubes SCNT and MCNT.

Similarly to the first embodiment, the metallic carbon nano tube MCNT and the semiconductor carbon nano tube SCNT are introduced from the introducing unit 2 into the transport unit 3. The band gap of the metallic carbon nano tube MCNT is 0 eV, and the band gap of the semiconductor carbon nano tube SCNT is larger than 0 eV and equal to or smaller than about 2.5 eV.

For example, when the inside of the transport unit 3 is in a vacuum state, the carbon nano tubes freely fall from the introducing unit 2 in the collecting units 4A and 4B through the magnetic field application region 3B of the transport unit 3.

When the inside of the transport unit 3 is filled with a gas or liquid, it is possible to make a flow of the gas and the liquid. However, in this case, the flow of the gas and liquid (hereinafter, referred to as a fluid) prefers to be a laminar flow. Whether the fluid flow becomes laminar or turbulent is based on an index represented by the Reynolds number.

The Reynolds number Re is a non-dimensional number defined by the ratio of an inertial force and a frictional force caused by the viscosity of a fluid, and is represented by the following Expression (8):

$$Re = \frac{UL}{( μ / ρ )} = \frac{UL}{v} \qquad ( 8 )$$

In the Expression (8), U represents the characteristic speed of the fluid ([m/s]), and L represents a characteristic length ([m]). In addition, μ represents viscosity or a viscosity coefficient ([m²/s]), ρ represents the density of the fluid ([Pa·s]), and ν represents the dynamic viscosity or dynamic viscosity coefficient of the fluid ([kg/m³]).

When the Reynolds number Re calculated by the above-mentioned expression is small, the viscous action of the fluid is relatively strong. When the Reynolds number Re is large, the inertial action thereof is relatively strong.

In the case in which the Reynolds number Re is used as an index for determining whether a fluid flow is turbulent or laminar, in general, the fluid flow is determined to be laminar when the Reynolds number of a fluid flowing through a circular pipe is about 2000 or smaller, and the fluid flow is determined to be turbulent when the Reynolds number of a fluid is about 4000 or larger. In addition, when a target object flowing in the fluid is a plate and the Reynolds number is 400000 or smaller, the fluid flow is laminar.

As in this embodiment, when the carbon nano tube is transported in the flow direction of the fluid, it is possible to adjust a falling speed (sedimentation), that is, the size of a transport vector, by appropriately selecting gas/liquid. In this way, it is possible to adjust the optimal conditions of the passing time of the carbon nano tubes MCNT and SCNT through the magnetic field application region 3B and increase the integrated time for which the magnetic field H is applied to the carbon nano tubes MCNT and SCNT.

When a non-conductive solvent is used as the liquid introduced into the transport unit 3, it has an effect of confining an overcurrent that partially flows through the carbon nano tubes MCNT and SCNT.

When a conductive solvent is used as the liquid, it is possible to form a pseudo current loop between the carbon nano tubes MCNT and SCNT and the conductive solvent. Therefore, it is possible to maintain the time for which an overcurrent flows to be constant, which is effective in separating the semiconductor and metallic carbon nano tubes.

The sedimentation speed is likely to be lowered due to the Brownian motion, and a turbulent flow is likely to occur due to the movement of the carbon nano tube (falling and sedimentation). The lowering of the sedimentation speed or the turbulent flow is most greatly affected in liquid, followed by gas and vacuum.

When the transport unit 3 is filled with gas, it is preferable that an inert gas be used for the carbon nano tubes SCNT and MCNT.

As in the first embodiment, when the carbon nano tubes are mechanically transported by, for example, a belt conveyer, it is easy to keep the transport speed (transport vector) constant. However, there is a concern that a sorting error will occur due to, for example, the vibration of a mechanical unit (belt conveyer) and adhesion caused by the intermolecular force (electrostatic force) generated between the carbon nano tube and a movable stage.

In contrast, as in the second embodiment, when the carbon nano tubes are transported by free falling or sedimentation, mechanical vibration or adhesion between the movable stage (belt) and the carbon nano tubes does not occur. In addition, it is possible to simplify the structure of the apparatus for sorting the carbon nano tubes.

The falling (sedimentation) speed of the carbon nano tube falling from the introducing unit 2 to the magnetic field application region 3B is the highest in vacuum, followed by gas and liquid. When the falling speed of the carbon nano tubes SCNT and MCNT is reduced, the time required for the carbon nano tube to pass through a magnetic field application portion is increased, and the integrated time for which the magnetic field H is applied to the carbon nano tubes SCNT and MCNT is increased. Therefore, it is possible to improve the efficiency of sorting out the semiconductor carbon nano tubes SCNT and the metallic carbon nano tubes MCNT.

Therefore, according to the second embodiment of the invention, it is possible to readily and effectively sort the carbon nano tubes according to their characteristics, similarly to the first embodiment. In addition, according to this embodiment, it is possible to improve the sorting accuracy of the carbon nano tubes.

### (3) Third Embodiment

In a third embodiment of the invention, a method of sorting carbon nano tubes according to their characteristics and properties before the carbon nano tubes are separated from a substrate 20 will be described with reference to FIGS. 10 to 12. In the third embodiment, substantially the same members as those in the first and second embodiments are denoted by the same reference numerals, and a detailed description thereof will be made if necessary.

As shown in FIG. 10, for example, in some cases, the carbon nano tubes MCNT and SCNT are formed by using a porous layer 25 that is formed on the substrate 20. The porous layer 25 includes a plurality of pores O. The pores O extend in a direction vertical to the upper surface of the substrate 20, and the pores O are substantially regularly arranged in the porous layer 25. For example, an alumite layer, a zeolite layer, or a mesoporous silica layer is used as the porous layer 25.

For example, when an alumite layer is used as the porous layer 25, the pores O may be formed by anodizing aluminum. Specifically, aluminum is electrolyzed and oxidized at a positive electrode using dilute sulfuric acid as the electrolyte. In this way, the porous layer 25 made of alumite and a plurality of pores O are formed. In this case, a porous layer (alumite layer) with a thickness of several nanometers to several ten of nanometers remains on the bottoms of the pores O, that is, on the substrate. Accordingly, after the anodizing is performed, reactive ion etching (RIE), sputtering or the like is performed on the entire surface to remove the porous layer 25 formed on the bottoms of the pores O, thereby exposing the surface of the substrate 20.

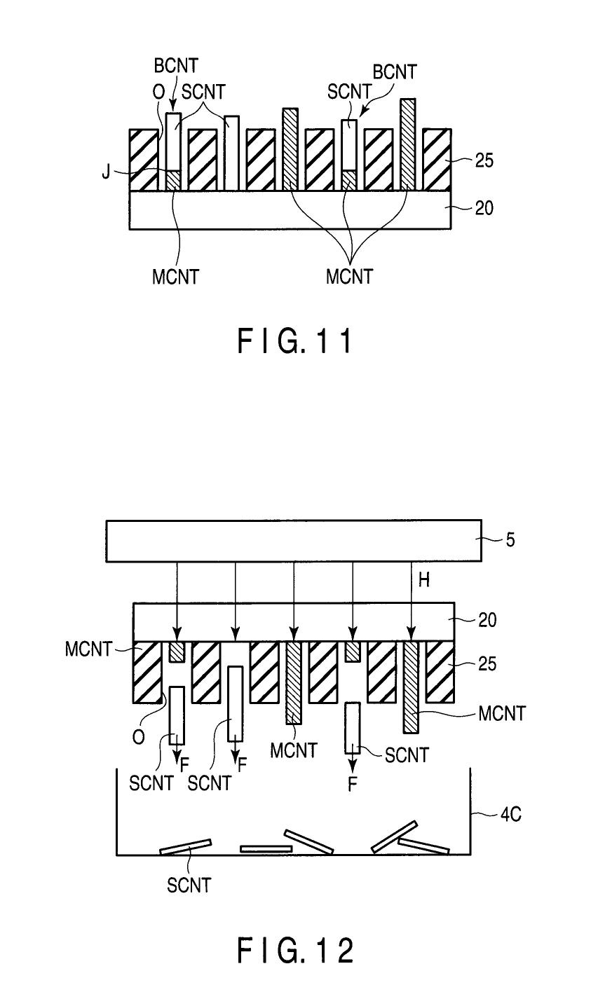

In the forming method using the porous layer 25, the formed carbon nano tubes SCNT and MCNT each have the structure shown in FIG. 11, for example.

The carbon nano tubes MCNT and SCNT are grown using the catalyst particles (for example, cobalt (Co) or nickel (Ni)) on the surface of the substrate 20 at the bottoms of the pores O as nuclei along the direction in which the pores extend. In this way, the carbon nano tubes MCNT and SCNT are formed in the pores O. The semiconductor carbon nano tubes SCNT or the metallic carbon nano tubes MCNT are formed using the catalyst particles as nuclei.

In some cases, the carbon nano tubes are formed to have a so-called bamboo-like structure using the catalyst particles on the surface of the substrate 20 as nuclei. Carbon nano tubes BCNT having the bamboo-like structure are grown and formed in a plurality of stages along the direction in which the pores O extend, and a joint J, such as a bamboo joint, is provided in one carbon nano tube. In some case, the carbon nano tube BCNT has different characteristics and properties between one side and the other side of the joint J as the boundary. By way of an example, in one carbon nano tube BCNT having the bamboo-like structure, a portion on the side of the substrate 20 is the metallic carbon nano tube MCNT, and the other portion on the upper side of the joint J, as the boundary, of the carbon nano tube is the semiconductor carbon nano tube SCNT.

In addition, in some cases, the bottoms of the carbon nano tubes SCNT and MCNT and the carbon nano tube BCNT having the bamboo-like structure directly contact with the substrate 20, and the catalyst particles exist at the upper ends of the carbon nano tubes. This is because, as the carbon nano tubes SCNT and MCNT are grown, the catalyst particles are moved in the direction in which the carbon nano tubes SCNT and MCNT are grown.

In this embodiment, the semiconductor carbon nano tube SCNT or a portion thereof is cut from the substrate 20 or the catalyst particles of the carbon nano tubes manufactured as described above and the carbon nano tube BCNT having the bamboo-like structure is cut at the joint J as the boundary, by the interaction (repulsive force F) between the magnetic characteristics of the carbon nano tubes and the magnetic field H. In this way, the semiconductor carbon nano tube is selectively extracted. Details of the method follow.

A chemical, such as a sulfuric acid, is used to remove the catalyst particles. When there are catalyst particles on the bottoms of the carbon nano tubes, the carbon nano tubes are separated in the chemical by the removal of the catalyst particles. For example, among the carbon nano tubes dispersed in the chemical, the semiconductor carbon nano tubes are selectively extracted by the method according to the first and second embodiments.

When there are catalyst particles at the upper ends of the carbon nano tubes, that is, when the bottoms of the carbon nano tubes are bonded to the substrate 20, the catalyst particles are removed by the chemical, but the carbon nano tubes maintain their bond with the substrate 20.

In particular, when the catalyst particles are ferromagnetic bodies, it is difficult to perform a method that will be described later. Therefore, it is preferable that, before the semiconductor carbon nano tubes are selectively separated from the substrate 20, the catalyst particles be removed using the chemical.

As shown in FIG. 12, the substrate 20 is reversed in the vertical direction such that the porous layer 25 faces downward and the substrate 20 faces upward. Then, the magnetic field H generated by the magnetic field generating unit 5 is applied from the bottom surface of the substrate 20 to the carbon nano tubes SCNT and MCNT formed on the substrate 20.

The semiconductor carbon nano tubes SCNT are cut from the substrate 20 by the repulsive force F generated by the interaction between the magnetic (diamagnetic) characteristics of the semiconductor carbon nano tubes SCNT and the magnetic field. In the example shown in FIG. 12, the cut off semiconductor carbon nano tubes SCNT fall freely and are collected in the collecting unit 4C.

On the other hand, since the metallic carbon nano tubes MCNT have paramagnetic characteristics, the repulsive force F caused by the magnetic field H is not applied to the metallic carbon nano tubes MCNT. Therefore, the metallic carbon nano tubes MCNT remain on the substrate 20 while maintaining the bonding state at the joints J.

As shown in FIG. 11, the carbon nano tube BCNT having the bamboo-like structure has the joint J. The interatomic boding strength of the joint J is weaker than that of the main bodies of the carbon nano tubes SCNT and MCNT.

In this embodiment, a weak etching process using a chemical, such as a dilute poly-dimethyl siloxane (PDMS), is performed on the carbon nano tubes SCNT and MCNT formed on the substrate 20. The process using a chemical, such as PDMS, may be performed before or after a process using a sulfuric acid.

The concentration of the etching solution (PDMS) is set to a value that does not decompose the carbon nano tubes and hardly damages the main bodies of the carbon nano tubes. However, as described above, since the bonding force of the joint J is weak, the bonding force of the joint J at the boundary is reduced even in a low-concentration solution.

Therefore, similarly to the above, as shown in FIG. 12, the substrate 20 is reversed in the vertical direction such that the porous layer 25 faces downward and the bottom surface of the substrate 20 faces upward. In this way, the magnetic field H generated by the magnetic field generating unit 5 is applied from the bottom surface of the substrate 20 to the carbon nano tubes SCNT and MONT formed on the substrate 20.

Since the bonding force of the joint J is reduced by the etching process using PDMS, a semiconductor portion (simply referred to as a semiconductor carbon nano tube) SCNT is cut from the substrate 20 at the joint J, which is the boundary, by the repulsive force F generated by the interaction between the magnetic (diamagnetic) characteristics of the semiconductor carbon nano tube and the magnetic field. In the example shown in FIG. 12, the cut off semiconductor carbon nano tubes SCNT fall freely and are then collected in the collecting unit 4C.

On the other hand, since a metallic portion (simply referred to as a metallic carbon nano tube) MCNT has paramagnetic characteristics, the repulsive force F caused by the magnetic field H is not applied to the metallic carbon nano tube. Therefore, the metallic carbon nano tube MCNT remains on the substrate 20 while maintaining its bonding state at the joint J. In this way, it is possible to sort out the semiconductor and metallic carbon nano tubes SCNT and MCNT having different band gaps.

In this embodiment, it is possible to sort out the semiconductor carbon nano tubes SCNT and the metallic carbon nano tubes MCNT without separating the carbon nano tubes SCNT and MCNT from the substrate 20. The semiconductor carbon nano tube SCNT is separated from the substrate 20 by the interaction with the magnetic field H, and the metallic carbon nano tube MCNT remains on the substrate 20.

As such, it is possible to simultaneously perform the sorting of the carbon nano tubes SCNT and MCNT according to their characteristics (band gaps) and the separation of the carbon nano tubes SCNT from the substrate 20. Therefore, according to this embodiment, it is possible to readily and effectively manufacture carbon nano tubes.

In addition, since a carbon nano tube having certain characteristics (in this embodiment, the metallic carbon nano tube MCNT) remains on the substrate 20, it is possible to achieve simplified and more effective device manufacturing processes, which will be described later, to which the carbon nano tube MCNT is applied.

Therefore, according to the third embodiment, similarly to the first and second embodiments, it is also possible to readily and effectively sort the carbon nano tubes according to their characteristics.

### (4) Fourth Embodiment

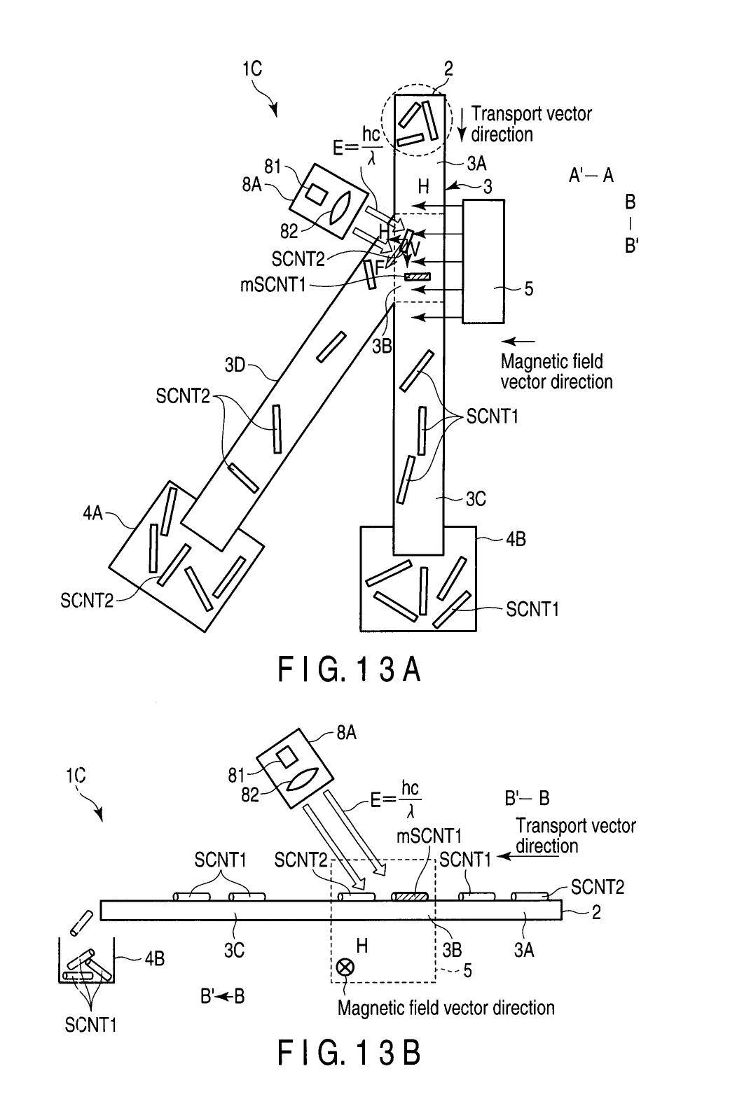

A fourth embodiment of the invention will be described with reference to FIGS. 13A to 15. In the fourth embodiment, substantially the same members as those in the first to third embodiments are denoted by the same reference numerals, and a detailed description thereof will be made if necessary.

In the first to third embodiments, the apparatus and method for sorting out the semiconductor carbon nano tubes SCNT and the metallic carbon nano tubes MCNT based on the difference in characteristics therebetween have been described.

As described above, the band gap of the metallic carbon nano tube MCNT is 0 eV, and the band gap of the semiconductor carbon nano tube SCNT is larger than 0 eV and equal to or smaller than 2.5 eV. Within the band gap range, in some cases, even when the semiconductor carbon nano tubes SCNT are formed on the same substrate under the same formation conditions, the semiconductor carbon nano tubes SCNT may have different band gaps.

In order to apply the semiconductor carbon nano tube to a more preferred device, it is preferable to further sort the semiconductor carbon nano tubes according to their band gaps.

Therefore, in the fourth embodiment of the invention, a method of sorting semiconductor carbon nano tubes SCNT1 and SCNT2 according to their different band gaps (Eg>0) will be described.

As described above, in the first to third embodiments of the invention, the semiconductor carbon nano tubes SCNT and the metallic carbon nano tubes MCNT are sorted out based on the difference between the magnetic characteristics caused by the presence and absence of free electrons in the carbon nano tubes.

The fourth embodiment of the invention sorts out the semiconductor carbon nano tubes SCNT1 and SCNT2 having different band gaps, in addition to the first to third embodiments.

Therefore, in this embodiment, a pre-process using the difference between the band gaps is performed while the carbon nano tubes are passing trough the magnetic field application region 3B.

Specifically, energy E for the transition of electrons from the valence band to the conduction band is applied to the semiconductor carbon nano tube having a certain band gap.

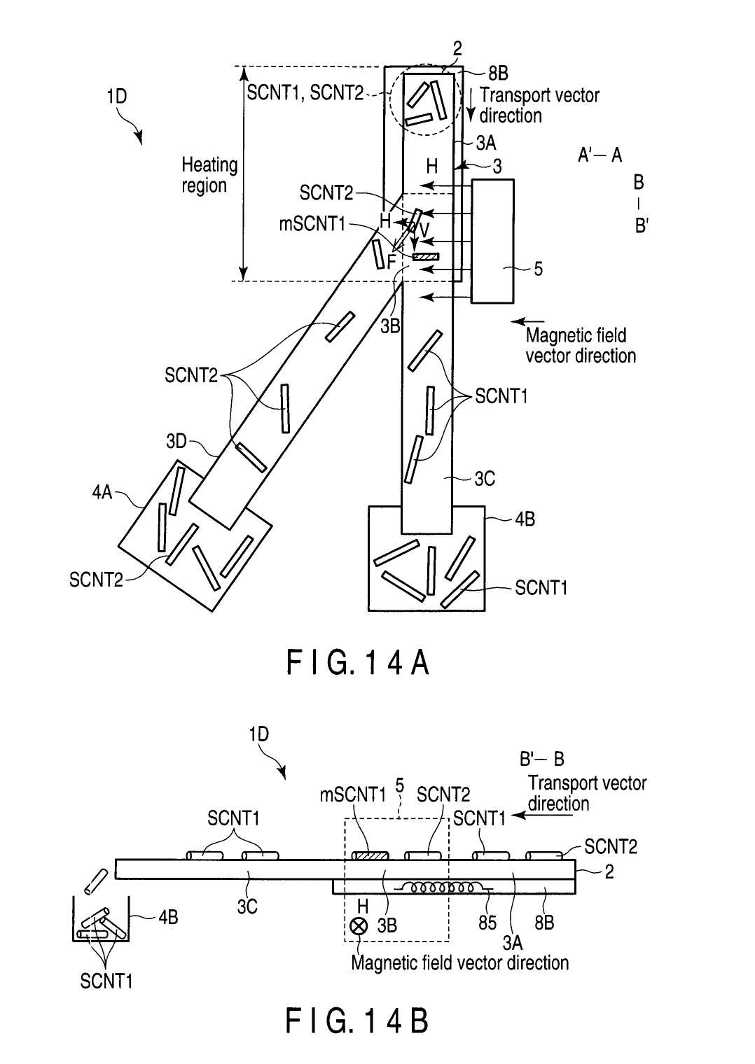

For example, as shown in FIGS. 13A to 14B, in order to apply the energy E, apparatuses 1C and 10 for sorting the carbon nano tubes further include exciting units 8A and 8B.

FIGS. 13A to 14B illustrate the structures of the apparatuses 1C and 1D for sorting the carbon nano tubes according to this embodiment, respectively. FIGS. 13A and 14A are plan views illustrating the structures of the apparatuses 1C and 10, and FIGS. 13B and 14B are cross-sectional views illustrating the structures of the apparatuses 1C and 10.

In the apparatus 1C for sorting the carbon nano tubes of the example shown in FIGS. 13A and 13B, the exciting unit 8A is, for example, a laser device. The laser device 8A includes, for example, a laser oscillator 81 and an optical system 82 having a lens and a mirror. The laser oscillator 81 may be at least one of a YAG laser, a glass laser, a ruby laser, and a dye laser. The wavelength of light emitted from the YAG laser and the glass laser is about 1.06 p.m. The wavelength of light emitted from the ruby laser is about 0.69 μm. The wavelength of light emitted from the dye laser is in the range of about 0.4 to 0.7 μm.

For example, the laser device 8A irradiates laser light to the carbon nano tubes SCNT1 and SCNT2 in the magnetic field application region 3B, thereby applying light energy to the carbon nano tubes SCNT1 and SCNT2.

As such, when laser light is applied to a plurality of carbon nano tubes SCNT1 and SCNT2, some of the plurality of carbon nano tubes having a band gap energy corresponding to the wavelength of the laser light or smaller are selectively excited.

In addition, the exciting unit may be a heating device 8B as in the apparatus 1D for sorting the carbon nano tubes shown in FIGS. 14A and 14B, instead of the laser device 8A.

The heating device 8B includes, for example, a Nichrome wire 85. The heating device 8B applies a current to the Nichrome wire 85 to directly heat the semiconductor carbon nano tubes SCNT1 and SCNT2 or apply heat thereto using radiation, in the range from the common portion 3A to the magnetic field application region 3B of the transport unit 3. The semiconductor carbon nano tubes SCNT1 and SCNT2 having a band gap energy corresponding to the amount of heat applied or smaller are excited, similarly to when the laser light is irradiated.

When the heating device 8B is used for heat excitation, a response speed from the application of external energy to the excitation of the carbon nano tube is lower than that when the laser device 8A is used for light excitation. Therefore, as shown in FIGS. 14A and 14B, it is preferable that the range from the common portion 3A to the magnetic field application region 3B be set as a heating region and thus heat is applied to the carbon nano tubes SCNT1 and SCNT2 while the carbon nano tubes are being transported in the common portion 3A such that the carbon nano tubes SCNT1 and SCNT2 are excited before they reach the magnetic field application region 3B.

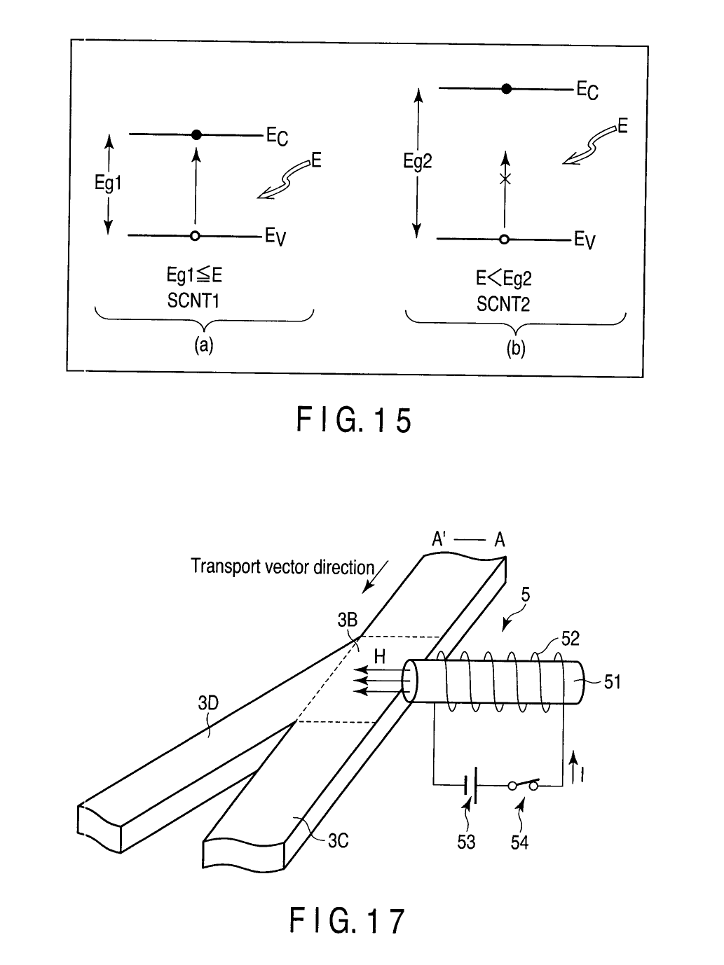

Next, an example of irradiating light to the semiconductor carbon nano tubes SCNT1 and SCNT2 having different band gaps to excite the semiconductor carbon nano tubes will be described with reference to FIG. 15. Here, the case in which the semiconductor carbon nano tubes SCNT1 and SCNT2 have a direct transition type band structure will be described.

The band gap Eg1 of the semiconductor carbon nano tube SCNT1 is smaller than the band gap Eg2 of the semiconductor carbon nano tube SCNT2. The laser device 8A outputs laser light having a wavelength λ. Taking the Plank's constant as h, the speed of light as c, and the wavelength of light as λ, the photon energy E of the laser light is E=hc/λ. The photon energy is applied as external energy E to the semiconductor carbon nano tubes SCNT1 and SCNT2. Here, the case in which the external energy (photon energy) E is equal to or larger than the energy corresponding to the band gap Eg1 and is smaller than the energy corresponding to the band gap Eg2 will be described.

Among a plurality of carbon nano tubes irradiated with the laser light, the semiconductor carbon nano tube SCNT1 having the band gap (band gap energy) Eg1 that is equal to or smaller than the external energy E=hc/λ absorbs laser light having a wavelength λ1, and electrons transit from a valence band Ev to a conduction band Ec and are then excited, as shown in the (a) of FIG. 15. Therefore, the number of free electrons in the surface of the carbon nano tube SCNT1 is increased, and the property of the carbon nano tube SCNT1 is changed into a pseudo metallic property. As a result, the magnetic characteristics of the semiconductor carbon nano tube SCNT1 in the excited state are closer to paramagnetic characteristics than to diamagnetic characteristics.

On the other hand, as shown in the (b) of FIG. 15, the semiconductor carbon nano tube SCNT2 has the band gap energy Eg2 larger than the external energy E=hc/λ. Therefore, the semiconductor carbon nano tube SCNT2 does not absorb laser light, and is not excited. As a result, the number of free electrons in the surface of the semiconductor carbon nano tube is not increased, and the semiconductor carbon nano tube SCNT2 having the band gap energy Eg2 does not express paramagnetic characteristics, but shows diamagnetic characteristics.

In addition, as shown in FIGS. 14A and 14B, when a heating process is performed to excite the semiconductor carbon nano tube SCNT1 having the band gap Eg1, the same effect as that when laser light is irradiated to excite the semiconductor carbon nano tube is obtained.

That is, when thermal energy capable of generating the transition of carriers having the band gap Eg1 between bands is applied as the external energy E to the semiconductor carbon nano tube SCNT1, electrons in the valence band transit to the conduction band by the thermal excitation of the electrons. As such, when the semiconductor carbon nano tube is excited, the magnetic characteristics of the carbon nano tube mSCNT1 are close to paramagnetic characteristics. In contrast, when the applied thermal energy is smaller than the band gap energy Eg2 of the semiconductor carbon nano tube SCNT2, the semiconductor carbon nano tube SCNT2 is not excited. Therefore, the semiconductor carbon nano tube SCNT2 has diamagnetic characteristics.

As shown in FIGS. 13A and 13B and FIGS. 14A and 14B, the external energy E and the magnetic field H are simultaneously applied to the semiconductor carbon nano tube mSCNT1 in the excited state and the semiconductor carbon nano tube SCNT2 in a non-excited state (normal state) in the magnetic field application region 3B. Since the semiconductor carbon nano tube SCNT2 in the non-excited state has diamagnetic characteristics, the semiconductor carbon nano tube SCNT2 is ejected from the magnetic field application region 3B to the branch portion 3D by the interaction with the magnetic field H.

As described above, the magnetic characteristics of the semiconductor carbon nano tube mSCNT1 in the excited state are close to paramagnetic characteristics. Therefore, the repulsive force caused by the magnetic field H is not applied to the semiconductor carbon nano tube mSCNT1 in the excited state, and the semiconductor carbon nano tube mSCNT1 is transported from the magnetic field application region 3B to the branch portion 3C by the transport vector. When no laser light is irradiated, the semiconductor carbon nano tube mSCNT1 returns from the excited state to a normal state.

Then, a plurality of semiconductor carbon nano tubes SCNT1 and SCNT2 having different band gaps Eg1 and Eg2 are collected in the collecting units 4A and 4B according to their band gaps, respectively.

In FIG. 15, the band structure of the semiconductor carbon nano tube is a direct transition type. However, the band structure of the semiconductor carbon nano tube may not be the direct transition type. An indirect transition type semiconductor carbon nano tube may be used. In this case, when the absorbed energy is larger than the energy corresponding to the band gap and electrons are then excited and the excited electrons are released, the electrons are heated by the interaction with phonons, and the carbon nano tube is excited.

As described above, when the external energy E is applied, the semiconductor carbon nano tube having a band gap (band gap energy) that is equal to or smaller than the external energy E is excited. Then, since there are a large number of excited electrons in the conduction band of the semiconductor carbon nano tube mSCNT1 in the excited state, the semiconductor carbon nano tube mSCNT1 becomes a pseudo-metallic carbon nano tube. As a result, the semiconductor carbon nano tube in the excited state shows paramagnetic characteristics.

On the other hand, the semiconductor carbon nano tube having a band gap larger than the applied energy is not excited. Therefore, even when external energy is applied, the semiconductor carbon nano tube SCNT2 in a normal state has diamagnetic characteristics. A repulsive force is generated from the carbon nano tube having the diamagnetic characteristics by the applied magnetic field H.

As such, in this embodiment, external energy is applied to excite the semiconductor carbon nano tube, and the magnetic characteristics of the semiconductor carbon nano tube having a band gap corresponding to the level of the energy are temporarily changed. By using this technique, it is possible to sort out the semiconductor carbon nano tubes having different band gaps.

When laser light is irradiated to excite the carbon nano tube, it is possible to change the wavelength λ of the irradiated laser light by changing the type of laser oscillator 81 used. Therefore, it is possible to sort out semiconductor carbon nano tubes having a desired band gap by selecting the wavelength λ of laser light from the range of the band gap of the carbon nano tube (0<Eg≦2.5). Similarly, when thermal energy generated by heating is applied to excite the carbon nano tube, it is also possible to sort out the semiconductor carbon nano tubes having a desired band gap by controlling the heating temperature. This contributes to improving the characteristics of a device using the semiconductor carbon nano tube or preventing a variation in the characteristics of the device.

In this embodiment, an example in which the apparatus 1A for sorting carbon nano tubes according to the first embodiment includes the exciting unit (laser device) 8A or the exciting unit (heating device) 8B has been described. However, the exciting unit 8A or the exciting unit 8B may be provided in the structure of the apparatus according to the second or third embodiment (see FIGS. 8, 9, and 12) such that external energy can be applied to the carbon nano tubes. In this case, it is also possible to obtain the same effects as those in this embodiment.

Therefore, in the fourth embodiment of the invention, similarly to the first to third embodiments, it is possible to readily and effectively sort carbon nano tubes, particularly, semiconductor carbon nano tubes according to their characteristics.

### (5) Fifth Embodiment

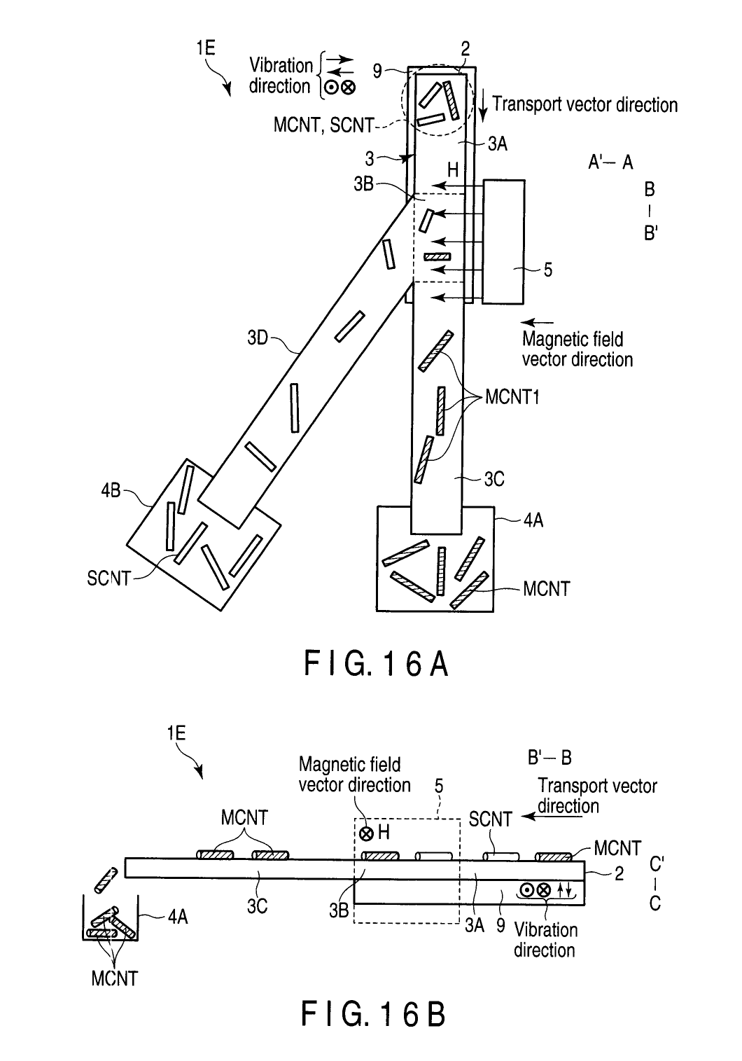

A fifth embodiment of the invention will be described with reference to FIGS. 16A and 16B. In the fifth embodiment, substantially the same members as those in the first to fourth embodiments are denoted by the same reference numerals, and a detailed description thereof will be made if necessary. FIG. 16A is a plan view illustrating the structure of an apparatus 1E, and FIG. 16B is a cross-sectional view illustrating the structure of the apparatus 1E.

The apparatus 1E for sorting carbon nano tubes shown in FIGS. 16A and 16B further includes a vibrating unit 9.

The vibrating unit 9 applies minute vibration to the carbon nano tubes SCNT, MCNT in the horizontal or vertical direction. For example, the vibrating unit 9 vibrates the carbon nano tube SCNT by generating a magnetic field, similarly to the magnetic field generating unit 5, and using the diamagnetic characteristics of the semiconductor carbon nano tube SCNT. As shown in FIGS. 16A and 16B, the vibrating unit 9 alternately generates a magnetic field in the direction vertical to the sheet of the drawings. That is, when the carbon nano tube is transported by the transport vector, the vibrating unit applies minute vibration to the carbon nano tube SCNT in a direction parallel to the direction from B to B′(or from B′ to B). Alternatively, the vibrating unit applies minute vibration to the carbon nano tube SCNT in a direction (direction C-C′) vertical to the surface of the transport unit 3 having the carbon nano tube loaded thereon.

As such, it is possible to prevent sorting errors due to the adhesion between the carbon nano tubes and the movable stage (belt conveyer) caused by the intermolecular force (electrostatic force) generated therebetween or the adhesion or entanglement between the carbon nano tubes when the carbon nano tubes are transported by selectively vibrating the semiconductor carbon nano tubes SCNT during transport.

The vibrating unit 9 may generate vibration at any stage before the carbon nano tubes SCNT and MCNT are sorted out according to their characteristics. Therefore, the vibrating unit 9 may be provided in any section from the common portion 3A to the magnetic field application region 3B of the transport unit 3.

As described above, according to the fifth embodiment of the invention, similarly to the first to third embodiments, it is possible to readily and effectively sort the carbon nano tubes according to their characteristics and improve the sorting accuracy of the carbon nano tubes.

FIGS. 16A and 16B show an example in which the apparatus according to the first embodiment includes the vibrating unit 9, but the invention is not limited thereto. The vibrating unit 9 may also be provided in the structures according to the second to fourth embodiments.

In particular, as in the third embodiment, when the semiconductor carbon nano tubes are selectively cut by the repulsive force caused by the magnetic field to sort the carbon nano tubes according to their characteristics, an external force caused by vibration may be applied to the carbon nano tubes. In this case, it is possible to effectively cut and sort out the semiconductor carbon nano tubes. In addition, it is possible to reduce the damage to the carbon nano tubes SCNT and MCNT due to etching.

### (6) Sixth Embodiment

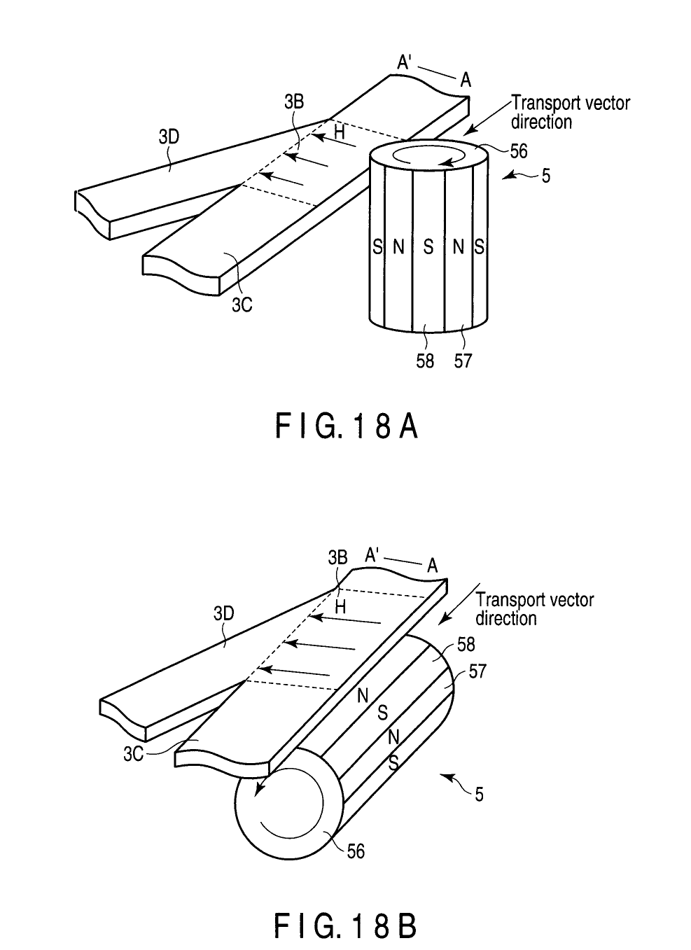

In the first to fifth embodiments of the invention, the overall structure of the apparatus for sorting the carbon nano tubes has been mainly described. In a sixth embodiment of the invention, an example of the structure of the magnetic field generating unit 5 will be described with reference to FIGS. 17, 18A, and 18B. In the sixth embodiment, substantially the same members as those in the first to fifth embodiments are denoted by the same reference numerals, and a detailed description thereof will be made if necessary.

In the example shown in FIG. 17, the magnetic field generating unit 5 is composed of an electromagnet. The electromagnet includes a ferromagnetic body (for example, iron (Fe)) 51 and a conducting wire (coil) that is wound around the magnetic body 51. The conducting wire 52 is connected to a power supply 53 and a switch 54.

When the switch 54 is turned on from off, a current I flows through the conducting wire 52, and the magnetic body 51 is magnetized. Thus, the magnetic field H is generated. When the switch is in the off state, the current I does not flow through the conducting wire 52, and the magnetic field H is not generated. The direction of the magnetic field H generated by the electromagnet is set so as to be aligned with a direction from the magnetic field generating unit 5 to the branch portion 3D (the direction from A to A′ in FIG. 17). The direction in which the current I flows and the direction in which the conducting wire 52 is wound are set according to the direction of the magnetic field H.

The magnetic flux density of the magnetic field generating unit 5 composed of the electromagnet can be changed by adjusting the amount of current flowing through the conducting wire 52. Therefore, the use of the electromagnet makes it possible to readily change the intensity of the magnetic field H applied to the carbon nano tubes.

Therefore, it is possible to prevent an external force other than the repulsive force generated by the magnetic field, which is caused by, for example, mechanical vibration, from being applied to the carbon nano tubes, as compared to the case where the magnetic field is changed by the operation of a permanent magnet, such as reciprocation of the magnet. As a result, it is possible to improve the sorting accuracy of the transported carbon nano tubes SCNT and MCNT.

FIGS. 18A and 18B show examples of the structure of the magnetic field generating unit 5 differing from that shown in FIG. 17. In the examples shown in FIGS. 18A and 18B, the magnetic field generating unit 5 has a structure in which magnetic bodies (ferromagnetic bodies) 57 and 58 are provided on the surface of a cylindrical rotating portion. The N-pole magnetic bodies 57 and the S-pole magnetic bodies 58 are alternately arranged on the rotating portion.

The magnetic field generating unit 5 shown in FIG. 18A is arranged adjacent to the side of the magnetic field application region 3B. The magnetic field generating unit 5 has a rotation axis that is vertical to the surface of the transport unit on which the carbon nano tubes are loaded. On the other hand, the magnetic field generating unit 5 shown in FIG. 18B is provided below the magnetic field application region 3B. The magnetic field generating unit 5 has a rotation axis that is parallel to the surface of the transport unit on which the carbon nano tubes are loaded.

In the magnetic field generating units 5 shown in FIGS. 18A and 18B, when the magnetic field H is generated, the rotating portion is rotated at a high speed. The rotating portion may be rotated in the clockwise direction or the counterclockwise direction.

As such, first, the magnetic field generating units 5 shown in FIGS. 18A and 18B apply the magnetic field to the diamagnetic semiconductor carbon nano tube SCNT such that the semiconductor carbon nano tube SCNT is attracted to the magnetic field application region 3B. Then, the magnetic field generating units 5 apply the magnetic field such that the semiconductor carbon nano tube SCNT is repulsed from the magnetic field application region 3B. This series of operations (rotations) cause the semiconductor carbon nano tube SCNT to be attracted substantially in the same direction as the transport vector, and the semiconductor carbon nano tube SCNT receives a strong repulsive force in the magnetic field application region 3B while being moved at a certain initial speed. Then, the semiconductor carbon nano tube SCNT is moved in a composite vector direction of the direction of the transport vector and the direction of the magnetic field vector. As a result, it is possible to accurately sort the semiconductor carbon nano tubes SCNT and the metallic carbon nano tubes MCNT.

As described above, according to the structures shown in FIGS. 17, 18A, and 18B, the magnetic field generating unit 5 applies the magnetic field H in the magnetic field application region 3B.

In this way, it is possible to sort carbon nano tubes according to their characteristics (band gaps) using the method and apparatus for sorting carbon nano tubes according to each of the first to fifth embodiments.

[Applications]

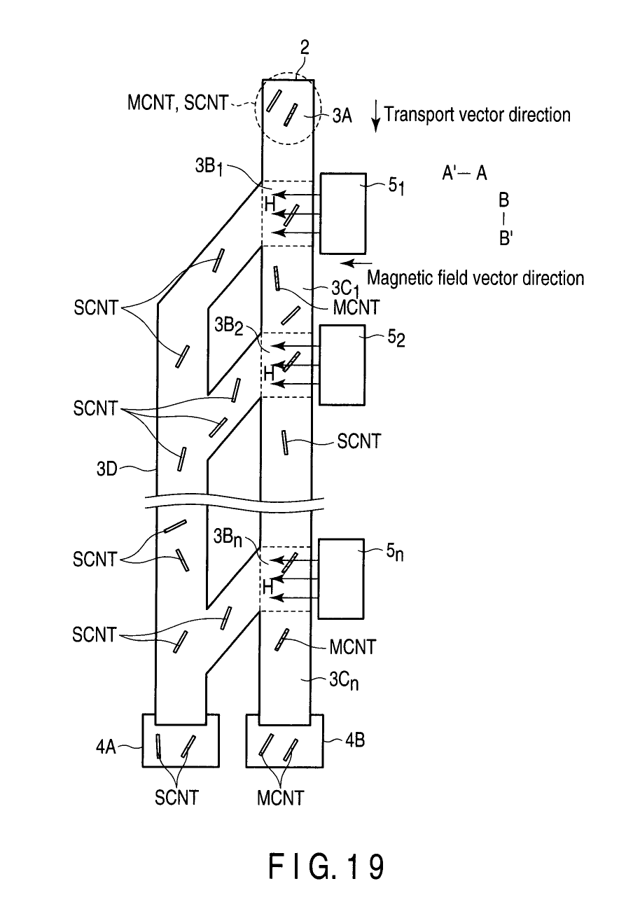

Applications of the embodiments according to the invention will be described with reference to FIGS. 19 to 21. In the description, substantially the same members as those in the first to sixth embodiments are denoted by the same reference numerals, and a detailed description thereof will be made if necessary.

An apparatus for sorting carbon nano tubes shown in FIG. 19 includes a plurality of magnetic field generating units 5₁ to 5ₙ arranged in series with each other. According to this structure, the semiconductor and metallic carbon nano tubes SCNT and MCNT are sequentially transported into a plurality of magnetic field application regions 3B₁ to 3Bₙ.

When a large number of carbon nano tubes SCNT and MCNT are transported at a same time, the movement of the semiconductor carbon nano tubes SCNT by the repulsive force is likely to be hindered by the other carbon nano tubes even when the semiconductor carbon nano tubes SCNT receive the repulsive force caused by the magnetic field H. As a result, the semiconductor carbon nano tubes SCNT and the metallic carbon nano tubes MCNT are likely to be collected in a mixed state, i.e., sorted out.

In an example having a plurality of magnetic field generating units 5₁ to 5ₙ shown in FIG. 19, when the semiconductor carbon nano tubes SCNT together with the metallic carbon nano tubes MCNT are transported to a branch portion 30₁ close to the collecting unit 4B without being sorted out by the magnetic field H of the first magnetic field generating unit 5₁, the magnetic field H of the second magnetic field generating unit 5₂ is applied to the semiconductor carbon nano tubes SCNT. Then, the diamagnetic semiconductor carbon nano tubes SCNT are sorted out into the branch portion 3D by the repulsive force caused by the magnetic field H of the second magnetic field generating unit 5₂.

As such, the sorting of the carbon nano tubes by the interaction between the magnetic (diamagnetic) characteristics of the semiconductor carbon nano tubes and the magnetic field H is repeatedly performed a plurality of times to accurately sort out the carbon nano tubes having different characteristics (band gaps).

The intensities of the magnetic fields H generated by the magnetic field generating units 5₁ to 5ₙ may be equal to or different from one another.

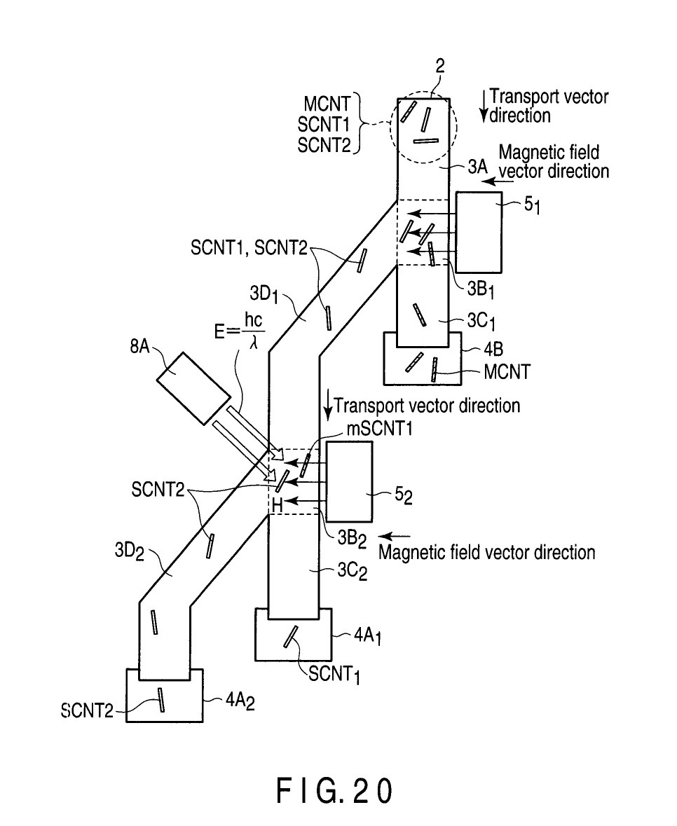

As shown in FIG. 20, after the semiconductor carbon nano tubes SCNT1 and SCNT2 and the metallic carbon nano tubes MCNT are sorted out, the semiconductor carbon nano tubes SCNT1 and SCNT2 may be subsequently sorted according to the sizes of their band gaps.

In the apparatus shown in FIG. 20, first, in the magnetic field application region 3B₁, the semiconductor carbon nano tubes SCNT1 and SCNT2 and the metallic carbon nano tubes MCNT are sorted by the interaction between the magnetic field H and the magnetic characteristics of the carbon nano tubes.

In this way, the metallic carbon nano tubes MCNT are collected into the collecting unit 4B.

Meanwhile, the semiconductor carbon nano tubes SCNT1 and SCNT2 are transported in the magnetic field application region 3B₂ through the branch portion 3D₁.

In the magnetic field application region 3B₂, external energy E (in this case, light energy) for exciting the semiconductor carbon nano tubes SCNT1 is applied to the semiconductor carbon nano tubes SCNT1 and SCNT2 having different band gaps. The external energy E is equal to or larger than the energy corresponding to the band gap of the semiconductor carbon nano tube SCNT1, and is smaller than the energy corresponding to the band gap of the semiconductor carbon nano tube SCNT2.

When the external energy E is applied, the semiconductor carbon nano tube mSCNT1 is excited and temporarily shows paramagnetic characteristics. On the other hand, since the energy applied to the semiconductor carbon nano tube SCNT2 to excite the semiconductor carbon nano tube SCNT2 is insufficient, the semiconductor carbon nano tube SCNT2 is not excited. Therefore, the diamagnetic characteristics of the semiconductor carbon nano tube SCNT2 are maintained.

In this way, in the magnetic field application region 3B₂, the semiconductor carbon nano tube SCNT2 is ejected to the branch portion 3D₂ by the repulsive force caused between its magnetic (diamagnetic) characteristics and the magnetic field H and is then collected into a collecting unit 4A₂. The semiconductor carbon nano tube mSCNT1 in the excited state does not receive the repulsive force caused by the magnetic field H. Therefore, the semiconductor carbon nano tube mSCNT1 is transported to the branch portion 3C₂ and is then collected into a collecting unit 4A_{I}.

In this way, it is possible to more effectively sort the carbon nano tubes according to their characteristics.

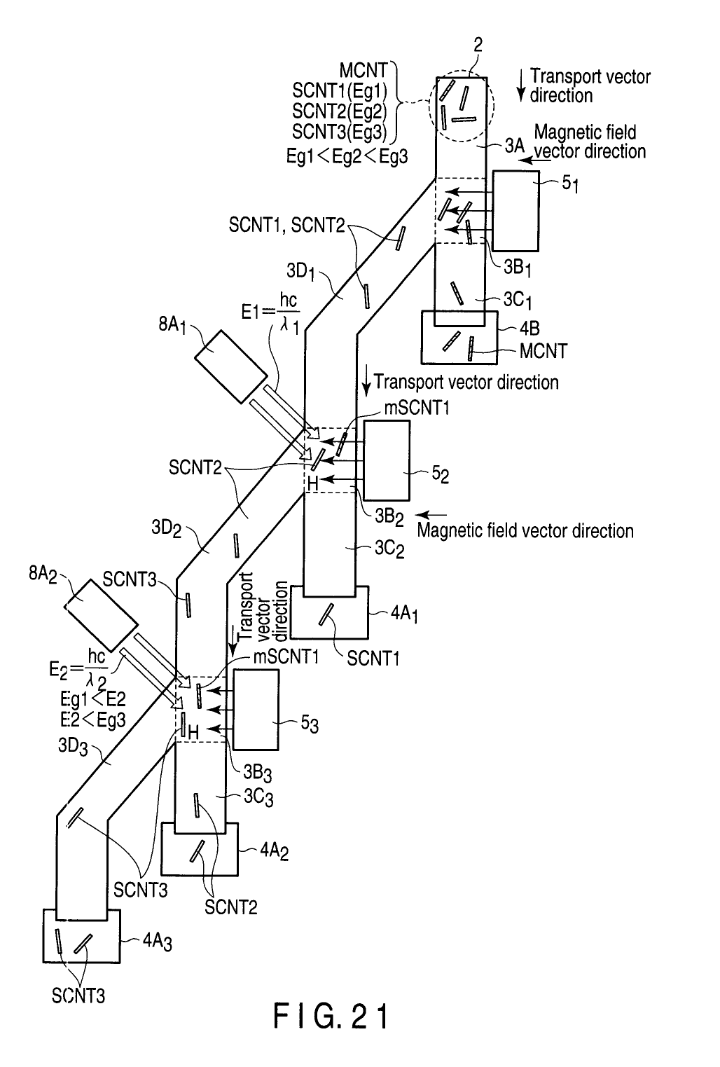

FIG. 20 shows the apparatus including one exciting unit 8A, but the invention is not limited thereto. For example, as shown in FIG. 21, the apparatus may include a plurality of exciting units 8A. When a plurality of exciting units 8A are provided, a more detailed sorting of the carbon nano tubes according to their band gaps is possible by making the intensities of external energy generated by the exciting units 8A different from one another. This will be described in detail with reference to FIG. 21.

In the example shown in FIG. 21, an exciting unit 8A₁ and an exciting unit 8A₂ are laser oscillators that emit laser beams having different wavelengths λ₁ and λ₂, respectively.

For example, similarly to the example shown in FIG. 20, first, the semiconductor carbon nano tubes and the metallic carbon nano tubes MCNT are sorted in the magnetic field application region 3B₁.

The sorted out semiconductor carbon nano tubes SCNT1, SCNT2, and SCNT3 have different band gaps. The semiconductor carbon nano tube SCNT1 has a band gap Eg1 and the semiconductor carbon nano tube SCNT2 has a band gap Eg2. The semiconductor carbon nano tube SCNT3 has a band gap Eg3. Among the band gaps Eg1, Eg2, and Eg3, the band gap Eg3 has the highest band gap energy, and the band gap Eg1 has the lowest band gap energy. The band gap Eg2 has a band gap energy of an intermediate value between the band gap Eg1 and the band gap Eg2.

The semiconductor carbon nano tubes SCNT1, SCNT2, and SCNT3 are transported from the branch portion 3D₁ to the magnetic field application region 3B₂.

In the magnetic field application region 3B₂, energy E₁ is applied to the semiconductor carbon nano tubes SCNT1, SCNT2, and SCNT3. The energy E₁ is larger than the energy corresponding to the band gap Eg1, and is smaller than the energy corresponding to the band gaps Eg2 and Eg3. Therefore, in the magnetic field application region 3B₂, the semiconductor carbon nano tube SCNT1 having the band gap Eg1 is excited by the energy E₁, and the semiconductor carbon nano tubes SCNT2 and SCNT3 respectively having the band gaps Eg2 and Eg3 are maintained in a normal state.

In this way, the semiconductor carbon nano tubes SCNT2 and SCNT3 are ejected into the branch portion 3D₂ by the interaction with the magnetic field H generated by the magnetic field generating unit 5₂. Meanwhile, the semiconductor carbon nano tube SCNT1 in the excited state is collected in the collecting unit 4A₁ through the branch portion 3C₂ by the transport vector.

The semiconductor carbon nano tubes SCNT2 and SCNT3 are transported to a magnetic field application region 3B₃. In the magnetic field application region 3B₃, the exciting unit 8A₂ applies energy E₂. The energy E₂ is equal to or larger than the energy corresponding to the band gap Eg2 and is smaller than the energy corresponding to the band gap Eg3. Therefore, in the magnetic field application region 3B₃, the semiconductor carbon nano tube mSCNT2 having the band gap Eg2 is excited, and the semiconductor carbon nano tube SCNT3 having the band gap Eg3 is maintained in a normal state. In this way, the semiconductor carbon nano tube mSCNT2 has paramagnetic characteristics during the excited state, and does not receive the repulsive force caused by the magnetic field H. On the other hand, the semiconductor carbon nano tube SCNT3 having the band gap Eg3 receives the repulsive force caused by the magnetic field H. Therefore, the semiconductor carbon nano tube SCNT2 having the band gap Eg2 is collected in the collecting unit 4A₂ through the branch portion 3C₃. The semiconductor carbon nano tube SCNT3 having the band gap Eg3 is collected in the collecting unit 4A₃ through the branch portion 3D₃.

In this way, it is possible to sort out the semiconductor carbon nano tubes SCNT1, SCNT2, and SCNT3 according to their band gaps corresponding to energy levels, by sequentially applying different energy levels to the semiconductor carbon nano tubes.

In FIGS. 20 and 21, the laser devices are used as the exciting units 8A₁ and 8A₂, but the invention is not limited thereto. For example, a heating device may be used to apply thermal energy to the semiconductor carbon nano tubes, or both the laser device and the heating device may be used.

As described with reference to FIGS. 19 to 21, it is possible to accurately and effectively sort carbon nano tubes according to their characteristics (sizes of band gaps) by appropriately combining the methods of sorting the carbon nano tubes according to the first to sixth embodiments of the invention.

### EXAMPLES

Hereinafter, examples of the carbon nano tubes sorted by the apparatuses and methods for sorting the carbon nano tubes described with reference to FIGS. 1 to 21 will be described.

(A) Process for Carbon Nano Tubes

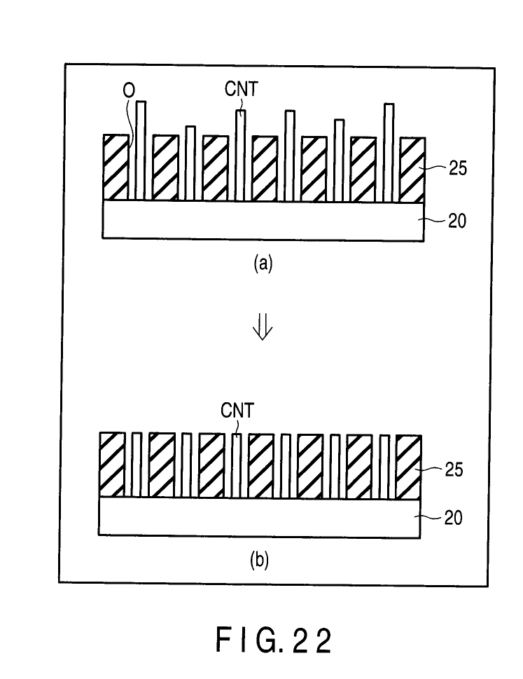

A process performed on the carbon nano tubes when the carbon nano tubes are employed in devices will be described with reference to FIGS. 22 to 27B.

(1) Uniformity in Shapes of Carbon Nano Tubes

As a process for the carbon nano tubes, a method of obtaining carbon nano tubes having the same shape (length) will be described with reference to FIG. 22.

For example, as described with FIGS. 10 and 11, in some cases, the carbon nano tubes are formed in the pores of the porous layer 25 made of, for example, alumite.

In this case, the formed carbon nano tubes CNT are grown in a direction that intersects the surface of the substrate. However, the formed carbon nano tubes CNT include both the semiconductor carbon nano tubes and the metallic carbon nano tubes.

In this case, as shown in the (a) of FIG. 22, the carbon nano tubes CNT are formed such that the upper ends thereof protrude from the opening portions of the pores. The upper ends of the carbon nano tubes CNT are polished by a chemical mechanical polishing (CMP) method using the upper surface of the porous layer 25 as a stopper. Thus, as shown in the (b) of FIG. 22, the lengths of a plurality of carbon nano tubes CNT formed on the same substrate are substantially equal to each other.

Then, the apparatus and method for sorting the carbon nano tubes according to each of the above-described embodiments are used to sort out the semiconductor and metallic carbon nano tubes having the same length according to their characteristics.

In this way, when the metallic and semiconductor carbon nano tubes CNT are employed in a device, which will be described later, it is possible to prevent a variation in element characteristics by making the lengths of a plurality of carbon nano tubes CNT formed on the same substrate equal to each other.

(2) Control of Arrangement of Carbon Nano Tubes

Next, a method of arranging the carbon nano tubes at predetermined positions on a substrate will be described. This method may be commonly applied to the metallic carbon nano tubes and the semiconductor carbon nano tubes.

### (a) First Example

When a solution including the carbon nano tubes flows on a substrate while the flow rate and flowing time thereof are controlled, a plurality of carbon nano tubes have a property of being arranged on the substrate along the direction in which the solution flows.

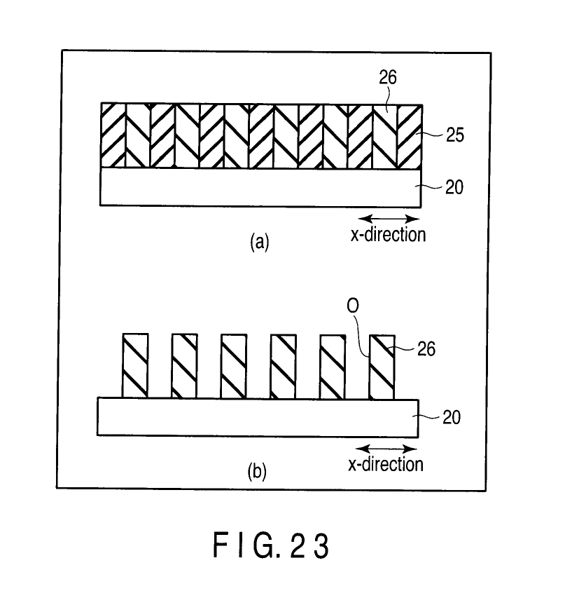

Next, an example of a method of arranging a plurality of carbon nano tubes at predetermined positions on the substrate at the same time using the above-mentioned property will be described with reference to FIGS. 23 to 25.

As shown in the (a) of FIG. 23, a porous layer (for example, an alumite layer) is formed on a substrate 20. Then, the pores of the porous layer 25 are filled with, for example, an insulator 26. The material filled in the pores is not limited to the insulating material and a conductive or semiconductor material may also be used as long as etching selectivity between the porous layer 25 and the material filled in the pores can be ensured.

Then, as shown in the (b) of FIG. 23, the porous layer is selectively removed. Then, insulating layers 26 remain on the substrate 20, and pillar-shaped insulating layers 26 (hereinafter, referred to as pillars 26) are arranged on the substrate 20. As described above, since the pores O formed in the porous layer are substantially regularly arranged, the pillars 26 provided in the pores are also regularly arranged on the substrate 20.

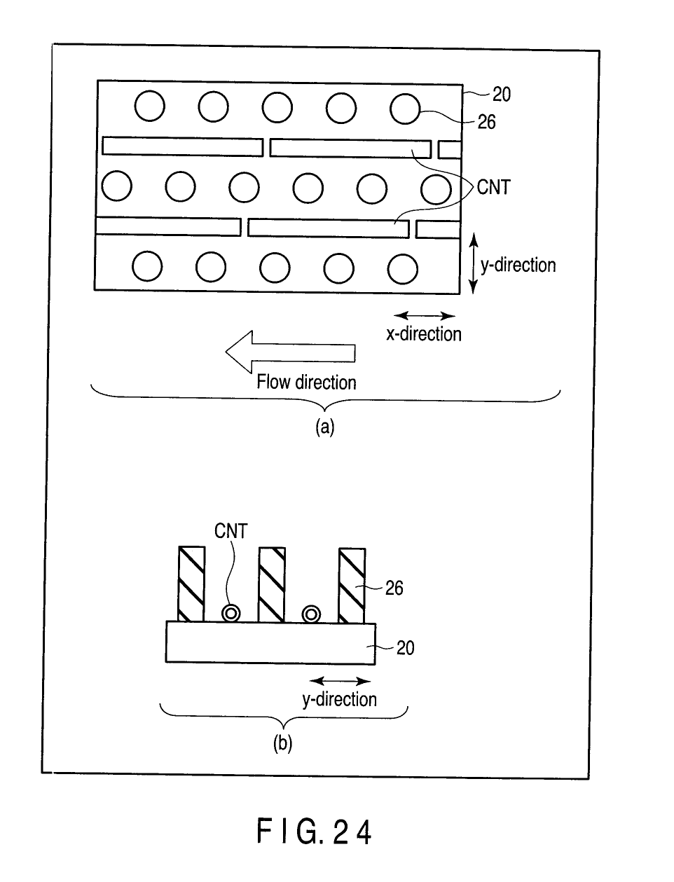

As shown in the (a) and (b) of FIG. 24, a solution including the carbon nano tubes CNT sorted by each of the above-described embodiments flows on the substrate 20 having a plurality of pillars 26 arranged thereon while the flow rate and flowing time of the solution are controlled. In the example shown in the (a) and (b) of FIG. 24, the direction in which the solution flows is set to, for example, the x direction.

When the solution is volatilized, the carbon nano tubes CNT are arranged in the x direction between the plurality of pillars 26 that are adjacent to each other in the y direction.

In this way, it is possible to regularly arrange a plurality of carbon nano tubes CNT on the substrate 20 according to the flow direction of the solution and the positions of the pillars 26 at the same time.

In the (a) and (b) of FIG. 23 and the (a) and (b) of FIG. 24, the porous layer is used to form the pillars 26 on the substrate 20, but the invention is not limited thereto. For example, an RIE method or a photolithography technique may be used to form three-dimensional structures made of an insulator or a conductor at predetermined positions on the substrate 20.

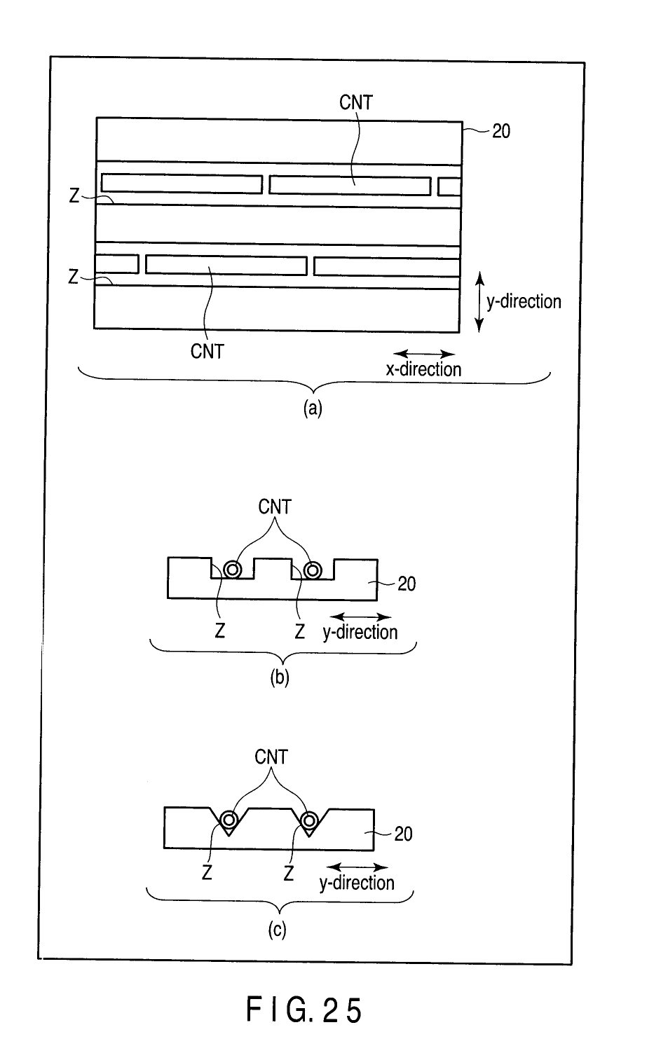

As shown in the (a) to (b) of FIG. 25, instead of the pillars 26 formed on the substrate 20, grooves Z may be formed in the substrate 20 using the photolithography technique and the RIE methods and a solution including the carbon nano tubes CNT may flow on the substrate 20. The (a) of FIG. 25 is a plan view illustrating the carbon nano tubes arranged on the substrate 20, and the (b) of FIG. 25 is a cross-sectional view taken along the y direction of the (a) of FIG. 25.

In this case, the carbon nano tubes CNT may be regularly arranged on the substrate 20 according to the positions of the groove Z. The grooves Z may be provided in an interlayer insulating layer that is formed on the substrate 20. In the (b) of FIG. 25, the groove Z has a rectangular shape in a cross-sectional view, but the invention is not limited thereto. The groove Z may have other shapes, for example, a triangular shape (V shape) as shown in the (c) of FIG. 25.

In this way, it is possible to simultaneously control the arrangement of a plurality of carbon nano tubes along the positions of the pillars 26 or the grooves Z by making a solution including the carbon nano tubes flow on the substrate having the pillars (structures) 26 formed thereon or the grooves Z formed therein.

This method can control a device to which the semiconductor and metallic carbon nano tubes are applied to be arranged at a predetermined position. In addition, according to the above-mentioned method, since it is possible to control the arrangement of a plurality of carbon nano tubes at the same time, it is possible to improve the manufacturing yield of devices using the carbon nano tubes.

### (b) Second Example

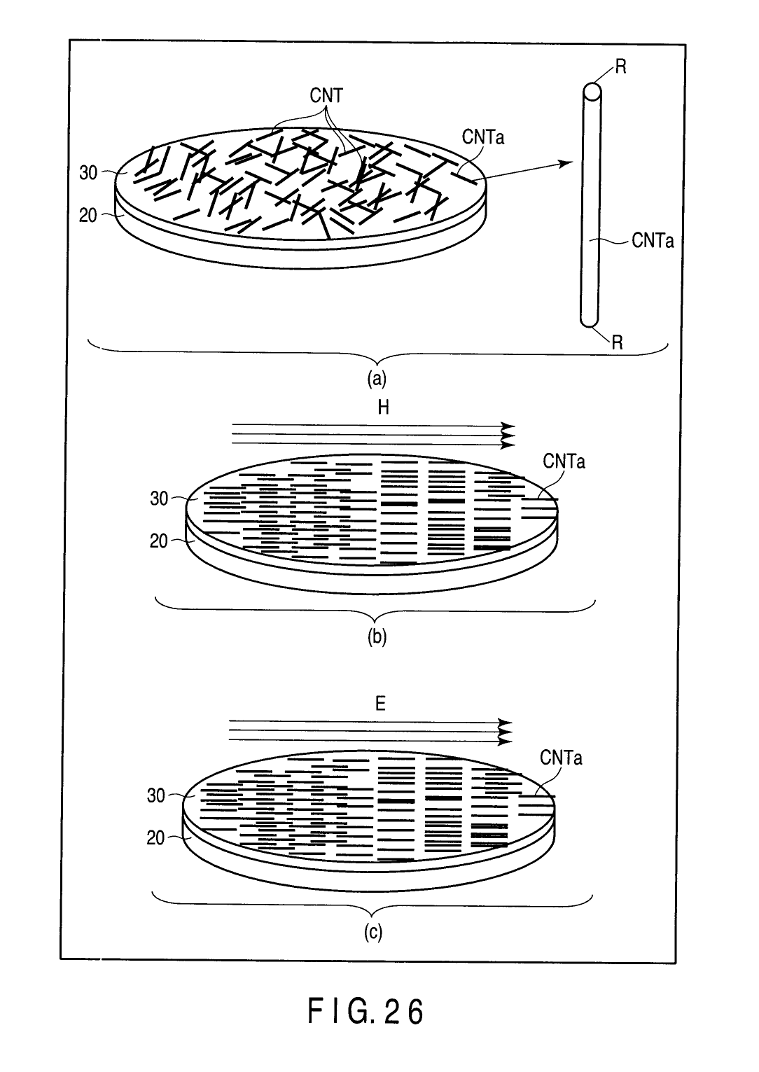

An example of a method of controlling the arrangement of carbon nano tubes will be described with reference to FIG. 26.

It has been known that, when the ends of the carbon nano tubes are opened in an oxygen atmosphere, a carboxyl group (—COOH) is added to the opened end. Here, an example of a method of controlling the arrangement of carbon nano tubes using the characteristics of the functional group added to the end of the carbon nano tube will be described.

As shown in the (a) of FIG. 26, for example, a resist 30 is coated on the substrate 20. Then, carbon nano tubes CNTa are dispersed in the resist 30.

The carbon nano tubes CNTa are sorted according to their characteristics (sizes of band gaps) by the apparatus and method according to each of the first to sixth embodiments. The ends of the sorted carbon nano tubes CNTa are opened, and atoms having magnetism or chelates R including the atoms are added to the opened ends (which is also referred to as chemical modification). Additionally or alternatively, molecules having magnetism may be added to the opened ends of the carbon nano tubes.

Then, as shown in the (b) of FIG. 26, the magnetic field H is applied to the carbon nano tubes CNTa on the resist 30. For example, the direction of the magnetic field H is parallel to the surface of the substrate 20. When the magnetic field H is applied, the carbon nano tubes CNTa electrophoretically migrate through the resist 30, and the ends having the atoms or chelates added thereto are aligned in the direction of the magnetic field H.

In this way, a plurality of carbon nano tubes CNTa are arranged in the same direction in the resist 30 on the substrate 20.

Instead of the atoms having magnetism or the chelates R including the atoms, charged atoms or the chelates R including the charged atoms may be added to the opened ends of the carbon nano tubes.

When the charged atoms or the chelates R including the charged atoms are added, as shown in the (c) of FIG. 26, an electric field E is used instead of the magnetic field. In this case, the carbon nano tubes CNTa are also aligned in the resist along the direction of the electric field E.

Both the atoms having magnetism or the chelates including the atoms and the charged atoms or the chelates including the charged atoms may be added to the opened ends of the carbon nano tubes.

As described above, when the atoms having magnetism or chargeability or the chelates including the atoms are added to the opened ends of the carbon nano tubes, it is possible to control the arrangement (alignment) of a plurality of carbon nano tubes CNTa on the substrate 20 using the magnetic field or the electric field.

### (c) Third Example

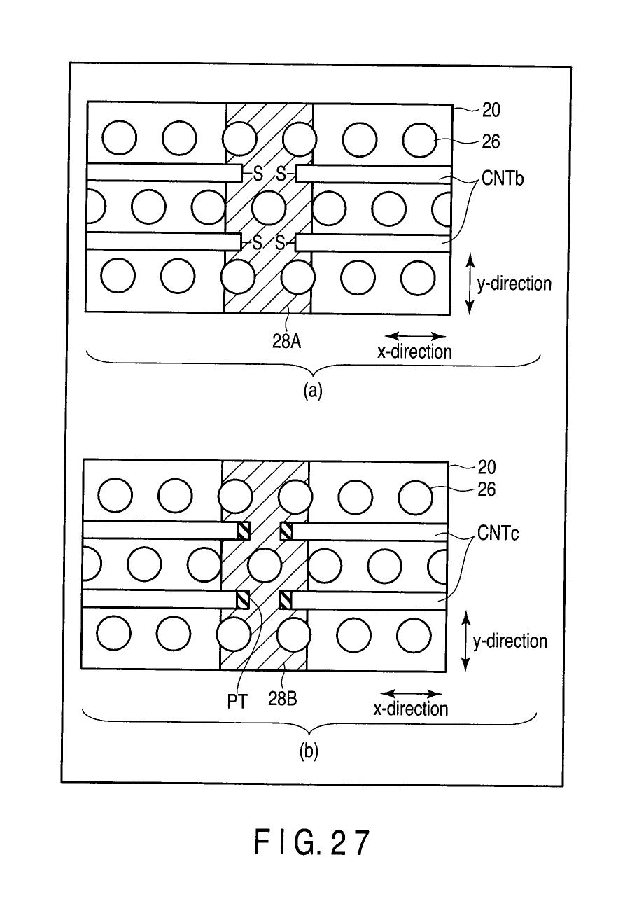

Next, a method of controlling the arrangement of carbon nano tubes will be described with reference to FIG. 27.

In this example, a method of controlling the arrangement of a plurality of carbon nano tubes on the substrate using the characteristics of the functional groups added to the opened ends of the carbon nano tubes (chemical modification) and electrically connecting the carbon nano tubes will be described.

It has been known that, when sulfur (S) comes into contact with gold (Au), covalent bonding is formed between the sulfur and the gold. Here, an example of using this action to control the arrangement of the carbon nano tubes and fix the arrangement of the carbon nano tubes will be described.

The ends of carbon nano tubes CNTb are opened in a gas atmosphere including sulfur, and molecules including sulfur (S) are added to the opened ends of the carbon nano tubes CNTb. The molecules including sulfur (S) also have, for example, a thiol group (—SH). Sulfur may be added to the opened ends of the carbon nano tubes CNTb.

On the substrate 20 having the carbon nano tubes arranged thereon, for example, a metal film 28A made of, for example, gold (Au) is selectively formed at a predetermined position where the ends of the carbon nano tubes CNTb are arranged. The material forming the metal film 28A is not limited to gold (Au), and the metal film 28A may be any film having covalent bonding with the thiol group.

In addition, the pillars 26 for controlling the alignment direction of the carbon nano tubes are formed on the substrate 20 shown in the (a) of FIG. 27.

Then, a solution including the carbon nano tubes CNTb having the thiol groups S added thereto flows on the substrate 20 having the metal film 28A formed thereon.

In this case, the leading ends of the carbon nano tubes having the thiol groups added thereto are attracted to the metal film 28A. Then, gold (Au) and sulfur (S) included in the thiol group are covalently bonded, and the leading ends of the carbon nano tubes CNTa are fixed to the metal film 28A by the binding force.

Instead of the thiol group, peptides may be added to the opened ends of the carbon nano tubes. The peptide is a polymer of a plurality of amino acids, and the peptide added in this example is, for example, an inorganic material-bound peptide. The inorganic material-bound peptide refers to peptide that is combined with a specific inorganic material to bond with the inorganic material by interaction therebetween. For example, the following inorganic materials are bound to the inorganic material-bound peptide: metal materials such as lead (Pb), platinum (Pt), silver (Ag), and titanium (Ti); inorganic compounds such as zinc oxide (ZnO), lead zirconate titanate (PZT), barium titanate (BaTiO₃), calcium molybdate (CaMoO₄); and semiconductor materials such as gallium arsenide (GaAs) and zinc sulfide (ZnS). Examples of the arrangement of the inorganic material-bound peptides bound to titanium (Ti) include the arrangement of KAKAKAKA, the arrangement of DKDKDKDK, and the arrangement of DADADADA, where K represents lysine, A represents alanine, and D represents asparagine acid.

As shown in the (b) of FIG. 27B, when the inorganic material-bound peptides PT are used, the inorganic material-bound peptides PT are added to the opened ends of the carbon nano tubes CNTc, and an inorganic film 28B is formed at a predetermined position on the substrate 20. The formed inorganic film 28B is a composite material that is bound to the added inorganic material-bound peptides.

Then, a solution including the carbon nano tubes CNTc having the inorganic material-bound peptides PT added thereto flows on the substrate 20, and the carbon nano tubes CNTc are arranged on the substrate 20. Portions of the carbon nano tubes CNTc having the inorganic material-bound peptides PT added thereto and the inorganic film 28B are bound to each other by interaction therebetween. In this way, the ends of the carbon nano tubes CNTc are fixed to the inorganic film 28B.

In the example shown in FIG. 27, a plurality of carbon nano tubes CNTb and CNTc share the metal film 28A or the inorganic film 28B.

As in the first example described with reference to FIG. 25, the flow of the solution including the carbon nano tubes on the substrate may be insufficient to electrically connect the carbon nano tubes. However, in this example, since the carbon nano tubes CNTa and CNTb share a conductive film, the carbon nano tubes are electrically connected to each other through the conductive films 28A and 28B, without being directly connected to each other.

The metal film 28A or the conductive inorganic film 28B may be used as, for example, an electrode or an interconnection of a device to which the carbon nano tubes are applied. In addition, the metal film 28A or the conductive inorganic film 28B may be selectively patterned such that a predetermined interconnection layout is formed, after the carbon nano tubes are fixed.

(B) Element Using Carbon Nano Tube

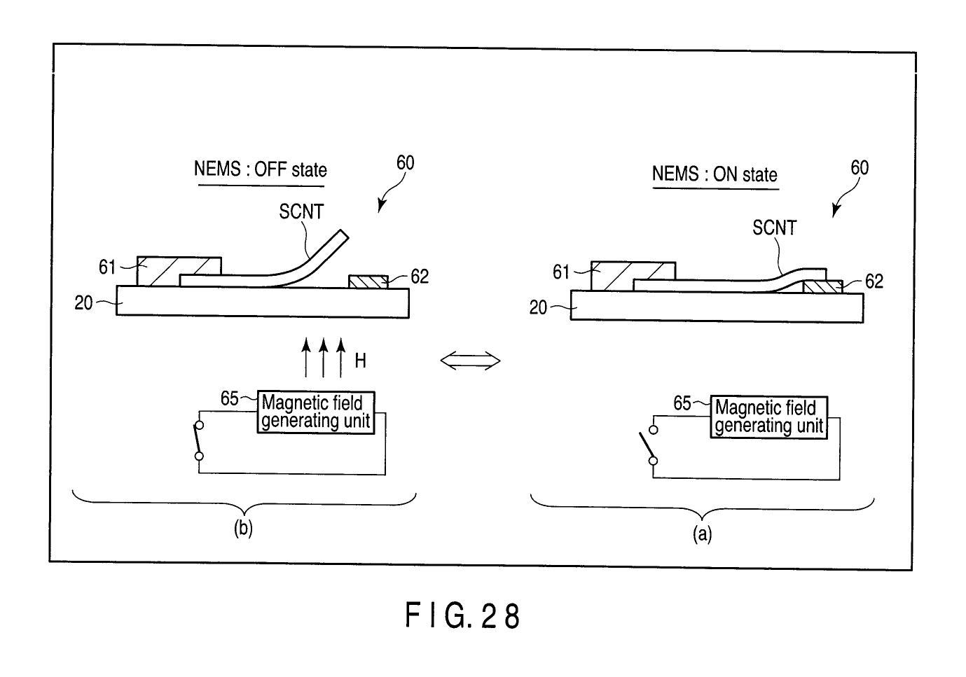

Hereinafter, devices to which the carbon nano tubes sorted by each of the above-described embodiments of the invention are applied will be described with reference to FIGS. 28 to 33.

(1) Switching Element

A switching element using the semiconductor carbon nano tube SCNT sorted out by each of the above-described embodiments of the invention will be described with reference to FIGS. 28A and 28B.

As described above, the semiconductor carbon nano tube has diamagnetic characteristics, and repulsive force is generated from the semiconductor carbon nano tube when the magnetic field is applied. The semiconductor carbon nano tube is applied to, for example, a nano-sized switching element (hereinafter, referred to as a nano electronics mechanical structure (NEMS) switching element) by using the physical property of the semiconductor carbon nano tube in which it is repulsed when receiving the magnetic field.

FIG. 28 is schematic diagram illustrating the structure and operation of the NEMS switching element using the semiconductor carbon nano tube.

First, the structure of the NEMS switching element will be described.

A NEMS switching element 60 is provided on a substrate 20. The substrate 20 is, for example, a semiconductor substrate (for example, a silicon substrate), an insulating substrate (for example, a glass substrate), or an interlayer insulating film.

The semiconductor carbon nano tube SCNT is provided on the substrate 20. For simplicity of explanation, one semiconductor carbon nano tube SCNT is shown, but a carbon nano tube group including a plurality of semiconductor carbon nano tubes may be used.

For example, one end of the semiconductor carbon nano tube SCNT is fixed to the substrate 20 by a conductive member 61, which is an anchor. The conductive member 61 also serves as, for example, an interconnection. In addition, an electrode 62 is provided on the substrate 20 so as to be connected to an end of the semiconductor carbon nano tube SCNT.

A magnetic field generating unit 65, serving as an actuator, is provided in order to apply the magnetic field H to the NEMS switching element 60. The contact/non-contact between the semiconductor carbon nano tube SCNT and the electrode 62 is controlled by the interaction between the magnetic field H generated by the magnetic field generating unit 65 and the semiconductor carbon nano tube SCNT having diamagnetic characteristics, such that the NEMS switching element 60 is turned on or off. In the example shown in FIGS. 28A and 28B, the direction of the magnetic field H is aligned with the direction from the bottom of the substrate 20 to the upper surface of the substrate 20.

As shown in the (a) of FIG. 28, when no magnetic field is applied from the outside, one end of the semiconductor carbon nano tube SCNT is connected to the electrode 62, and the NEMS switching element 60 using the semiconductor carbon nano tube SCNT is turned on.

On the other hand, as shown in the (b) of FIG. 28, when the magnetic field H is applied from the outside, the repulsive force caused by the magnetic field H applied to the semiconductor carbon nano tube is given to the semiconductor carbon nano tube SCNT by the diamagnetic characteristics of the semiconductor carbon nano tube SCNT, and the one end of the semiconductor carbon nano tube SCNT is separated from the electrode 62. Thus, the NEMS switching element 60 is turned off.

When the state in which the magnetic field H is not applied is referred to as a normal state, the NEMS switching element 60 is a normally-on switching element.

In the structure shown in FIGS. 28A and 28B, when the NEMS switching element 60 using the semiconductor carbon nano tube and the magnetic field generating unit 65 are formed on the same chip, it is preferable that the magnetic field generating unit 65, serving as an actuator, be formed below the semiconductor carbon nano tube SCNT. Then, the semiconductor carbon nano tube SCNT used as the NEMS switching element is provided on an interlayer insulating film that covers the magnetic field generating unit 65.

When the NEMS switching element 60 and the magnetic field generating unit 65 are formed on different chips, it is preferable that the chip having the NEMS switching element 60 formed thereon be laminated on the chip having the magnetic field generating unit 65 formed thereon.

As described above, the semiconductor carbon nano tubes SCNT are sorted out by the apparatus and method for sorting the carbon nano tubes according to each of the above-described embodiments of the invention, and the sorted out carbon nano tubes SCNT are applied to, for example, the NEMS switching element. The carbon nano tubes sorted out by the method according to each of the above-described embodiments have substantially the same characteristics (substantially the same band gap). Therefore, it is possible to apply the carbon nano tubes having the same characteristics to prevent a variation in the characteristics of the NEMS switching element.

As a result, it is possible to provide a NEMS switch whose characteristic variation is prevented by using the apparatus and method for sorting the carbon nano tubes according to one of the above-described embodiments of the invention.

(2) Transistor

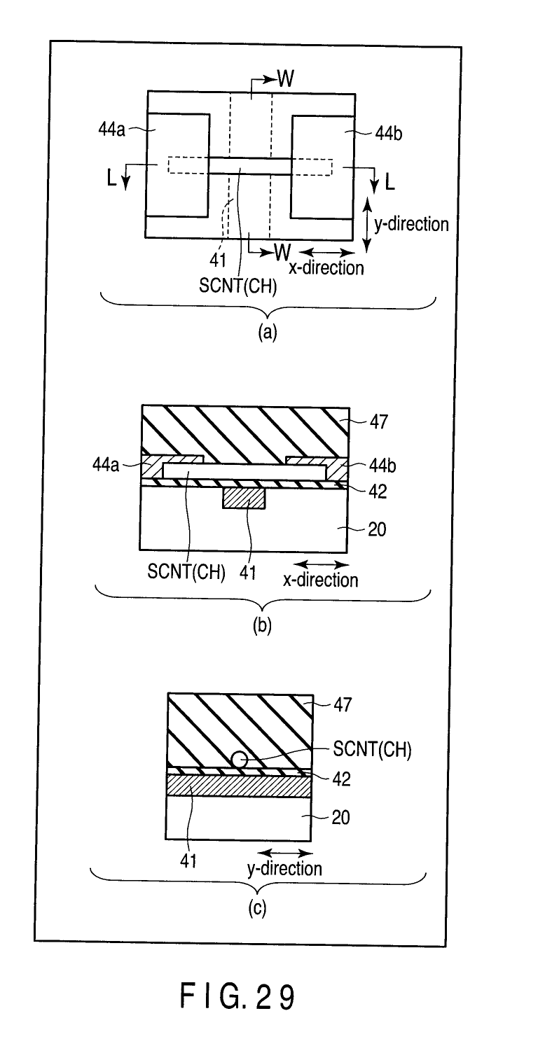

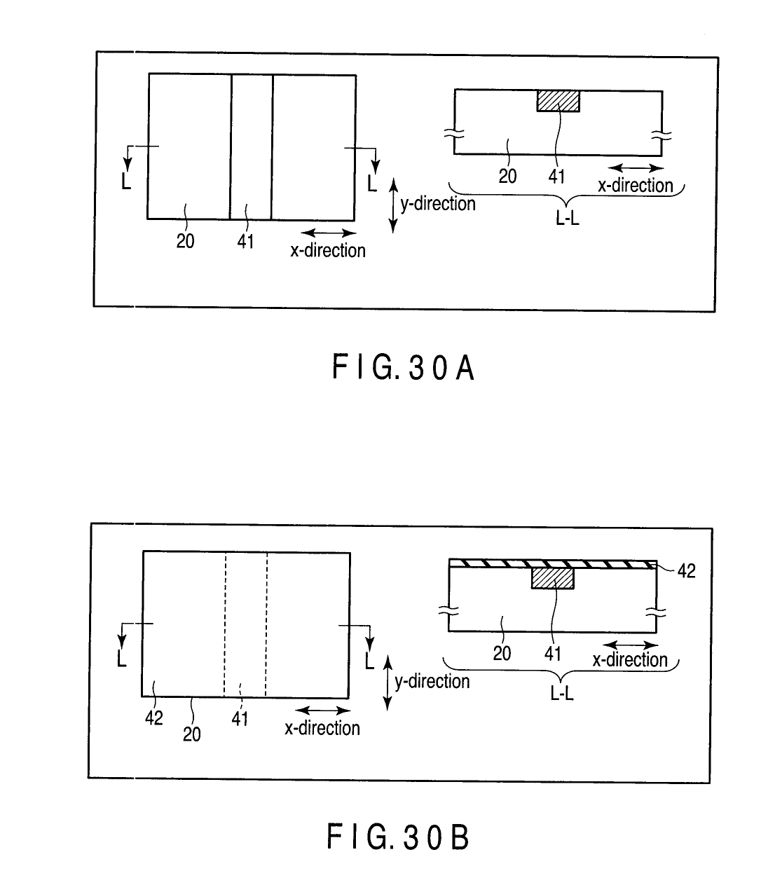

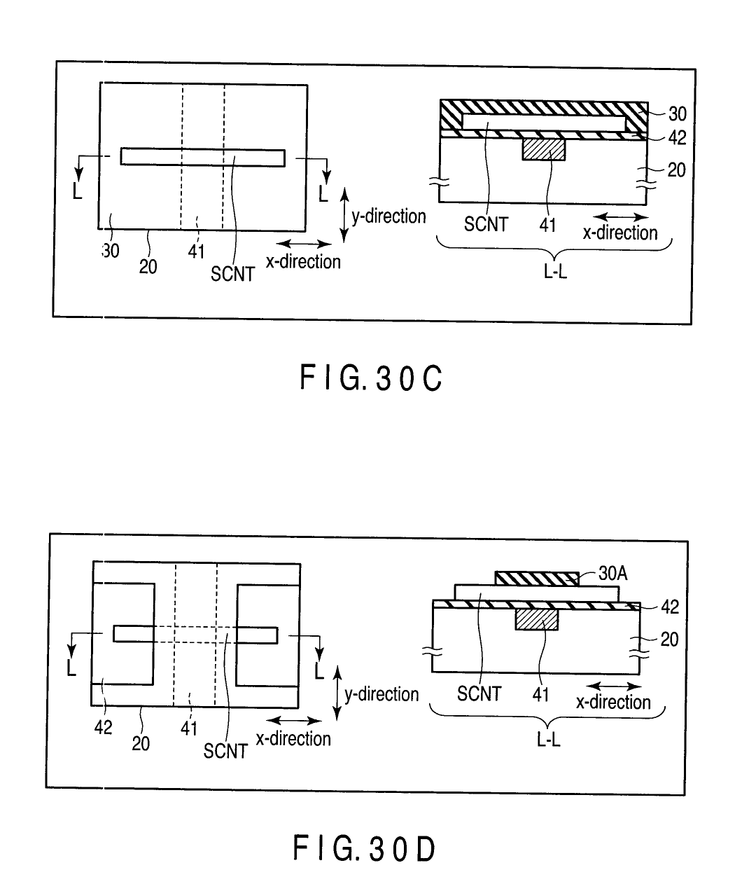

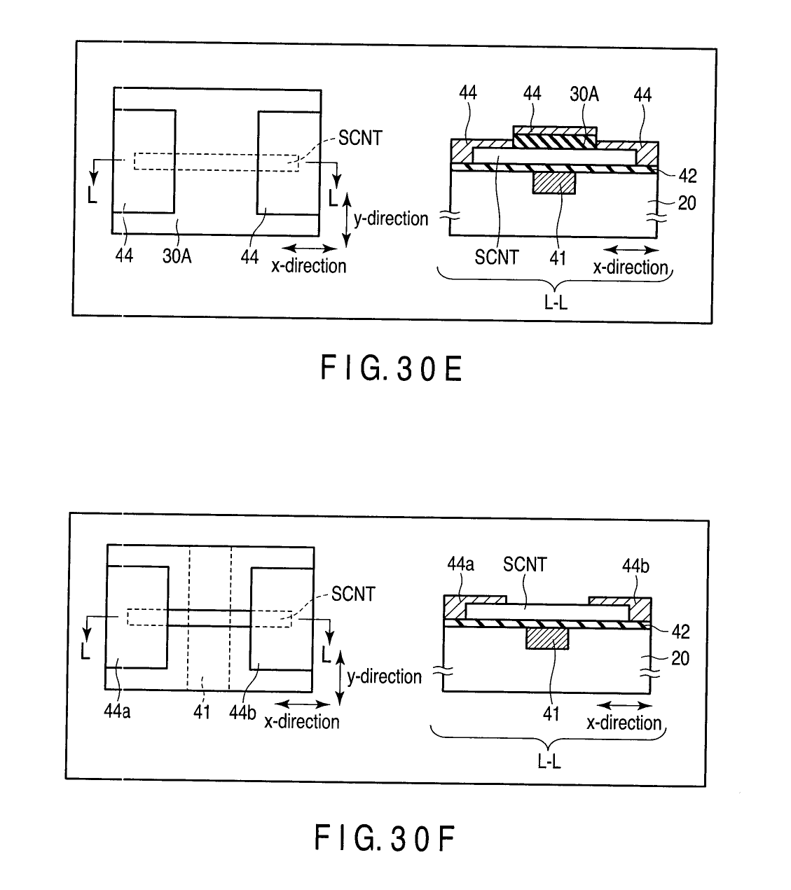

Next, an example in which the semiconductor carbon nano tube sorted out by each of the above-described embodiments of the invention is applied to a field effect transistor will be described with reference to FIGS. 29 to 30F.

(a) Structure

The structure of a field effect transistor using the semiconductor carbon nano tube SCNT will be described with reference to FIG. 29. In the following description, the field effect transistor using the semiconductor carbon nano tube SCNT is referred to as a CNT transistor.

The (a) of FIG. 29 is a plan view illustrating the structure of the CNT transistor. The (b) of FIG. 29 is a cross-sectional view taken along the line L-L of the (a) of FIG. 29, and the (c) of FIG. 29 is a cross-sectional view taken along the line W-W of the (a) of FIG. 29. The line L-L corresponds to the cross section in the channel length direction of the CNT transistor, and the line W-W corresponds to the cross section in the channel width direction of the CNT transistor.

As shown in FIG. 29, a gate electrode 41 of the CNT transistor is provided in a groove that is formed in a substrate 20. The gate electrode 41 extends in the y direction (channel width direction). The substrate 20 may be a semiconductor substrate, such as a silicon substrate, a silicon carbide (SiC) substrate, or an insulating substrate.

A gate insulating film 42 is provided on the gate electrode 41 and the substrate 20.

The semiconductor carbon nano tube SCNT is provided on the gate insulating film 42.

Source and drain electrodes 44a and 44b are provided at one end and the other end of the semiconductor carbon nano tube SCNT, respectively.

A portion of the semiconductor carbon nano tube SCNT facing the gate electrode 41 serves as a channel region CH. In addition, portions of the semiconductor carbon nano tube SCNT contacting the source and drain electrodes 44a and 44b serve as a source and a drain, respectively.

An interlayer insulating film 47 is provided on the semiconductor carbon nano tube SCNT and the source and drain electrodes 44a and 44b.

The semiconductor carbon nano tube SCNT used for the transistor is sorted out by the method according to each of the above-described embodiments of the invention.

The semiconductor carbon nano tube SCNT sorted out by the apparatus and method described in each of the above-described embodiments of the invention can be applied to the CNT transistor.

According to the apparatus and method for sorting the carbon nano tubes according to each of the first to sixth embodiments, it is possible to sort out the semiconductor carbon nano tubes having substantially the same band gap. Therefore, a plurality of semiconductor carbon nano tubes SCNT having the same band gap can be applied to the CNT transistors. As a result, it is possible to prevent a variation in the characteristics of the CNT transistors.

FIG. 29 show the structure of one CNT transistor including one semiconductor carbon nano tube SCNT, for simplicity of explanation. However, a plurality of carbon nano tubes SCNT may be used for one CNT transistor. In this case, in some cases in the related art, the on-current of the CNT transistor varies due to a variation in the number of carbon nano tubes. However, according to the apparatus and method for sorting the carbon nano tubes according to each of the first to sixth embodiments, the semiconductor carbon nano tubes SCNT can be sorted out so as to have substantially the same characteristics (the same band gap). In this way, even when a plurality of carbon nano tubes are included in the CNT transistor, a variation in the on-current of the CNT transistor is prevented.

Therefore, it is possible to provide a CNT transistor whose characteristic variation is prevented by using the apparatus and method for sorting the carbon nano tubes according to each of the embodiments of the invention.

(b) Manufacturing Method

Next, a method of manufacturing a field effect transistor (CNT transistor) using the carbon nano tube will be described with reference to FIGS. 29 to 30F.

FIGS. 29 to 30F show one CNT transistor forming region.

A method of manufacturing the CNT transistor will be described with reference to FIG. 30A.

FIG. 30A shows a plan view illustrating a process of the method of manufacturing the CNT transistor and a cross-sectional view taken along the line L-L (channel length direction).

As shown in FIG. 30A, a groove is formed in a substrate 20 so as to extend in the y direction (channel width direction). Then, a gate electrode material is deposited on the surface of the substrate 20 by a thin film deposition technique, such as a sputtering method or a chemical vapor deposition (CVD) method. Then, for example, an etching process or a chemical mechanical polishing (CMP) method is performed on the gate electrode material to allow a metal film to remain in the groove in a self-aligned manner. In this way, a gate electrode 41 is formed in the substrate 20.

FIG. 30B shows a plan view illustrating a process of the method of manufacturing the CNT transistor and a cross-sectional view taken along the line L-L.

As shown in FIG. 30B, a gate insulating film 42 is formed on the substrate 20 and the gate electrode 41 by, for example, a CVD method or a thermal oxidation method.

The method of manufacturing the CNT transistor will be described with reference to FIG. 30C.

FIG. 30C shows a plan view illustrating a process of the method of manufacturing the CNT transistor and a cross-sectional view taken along the line L-L (channel length direction).

As shown in FIG. 30C, a resist 30 is coated on the gate insulating film 42, and the semiconductor carbon nano tube SCNT is dispersed on the resist. The semiconductor carbon nano tube SCNT is sorted out by the apparatus and method according to each of the above-described embodiments according to the characteristics (sizes of band gaps).

In order to uniformize the characteristics and arrangement of the semiconductor carbon nano tubes SCNT, as in the method described with reference to FIG. 26, atoms having magnetism or chargeability or chelates including the atoms may be added to the ends of the semiconductor carbon nano tubes SCNT in advance, and a magnetic field or an electric field may be applied to the semiconductor carbon nano tubes SCNT in the resist 30 in the x direction to control the arrangement of the carbon nano tubes. In addition, the method described with reference to FIG. 27 may be used. That is, the thiol groups or the inorganic material-bound peptides are added to the ends of the semiconductor carbon nano tubes SCNT in advance, and a film that is bound to the thiol groups or the inorganic material-bound peptides is formed at a predetermined position on the substrate 20 to fix the semiconductor carbon nano tubes SCNT at predetermined positions on the substrate 20, thereby controlling the arrangement of the carbon nano tubes SCNT.

FIG. 30D shows a plan view illustrating a process of the method of manufacturing the CNT transistor and a cross-sectional view taken along the line L-L.

As shown in FIG. 30D, a resist 30A is patterned by a photolithography technique. In this way, a portion of the semiconductor carbon nano tube SCNT corresponding to a channel region is covered by the resist 30A. In addition, portions of the semiconductor carbon nano tube corresponding to source and drain regions are exposed.

In this process, for example, in order to partition CNT transistor regions (hereinafter, referred to as transistor forming regions), element isolation grooves (not shown) are formed in the substrate 20. When the lengths of the carbon nano tubes are not uniform, some carbon nano tubes may cross adjacent transistor forming regions. However, when the element isolation grooves are formed, the carbon nano tubes on the element isolation regions (element isolation grooves) are partitioned by RIE. Therefore, it is possible to prevent one carbon nano tube from being laid across two transistor forming regions. As a result, it is possible to prevent element defects.

The method of manufacturing the CNT transistor will be described with reference to FIG. 30E.

FIG. 30E shows a plan view illustrating a process of the method of manufacturing the CNT transistor and a cross-sectional view taken along the line L-L (channel length direction).

As shown in FIG. 30E, a metal film 44 is deposited on the resist 30A and the semiconductor carbon nano tube SCNT by, for example, a sputtering method. In this case, a portion of the semiconductor carbon nano tube SCNT corresponding to the channel region is covered by the resist 30A. Therefore, the metal film 44 is deposited on the resist 30A on the channel region. In addition, the metal film 44 is formed so as to be directly contacted with portions of the semiconductor carbon nano tube SCNT corresponding to the source and drain regions.

FIG. 30F shows a plan view illustrating a process of the method of manufacturing the CNT transistor and a cross-sectional view taken along the line L-L.

Then, when the resist 30A peels off, the metal film 44 on the resist 30A also peels off at the same time. Therefore, as shown in FIG. 30F, a portion of the semiconductor carbon nano tube SCNT corresponding to the channel region is exposed, and the source and drain electrodes 44a and 44b are formed on portions thereof corresponding to the source and drain regions.

Then, as shown in FIGS. 29A to 29C, an interlayer insulating film 47 is formed on the substrate 20 so as to cover the semiconductor carbon nano tube SCNT. In this way, the CNT transistor using the semiconductor carbon nano tube SCNT is completed.

As described above, the semiconductor carbon nano tubes are sorted by the apparatus and method for sorting carbon nano tubes according to each of the first to sixth embodiments of the invention. Thus, a field effect transistor (CNT transistor) using the sorted out semiconductor carbon nano tube SCNT is manufactured by the manufacturing method shown in FIGS. 29 to 30F.

(3) Interconnection

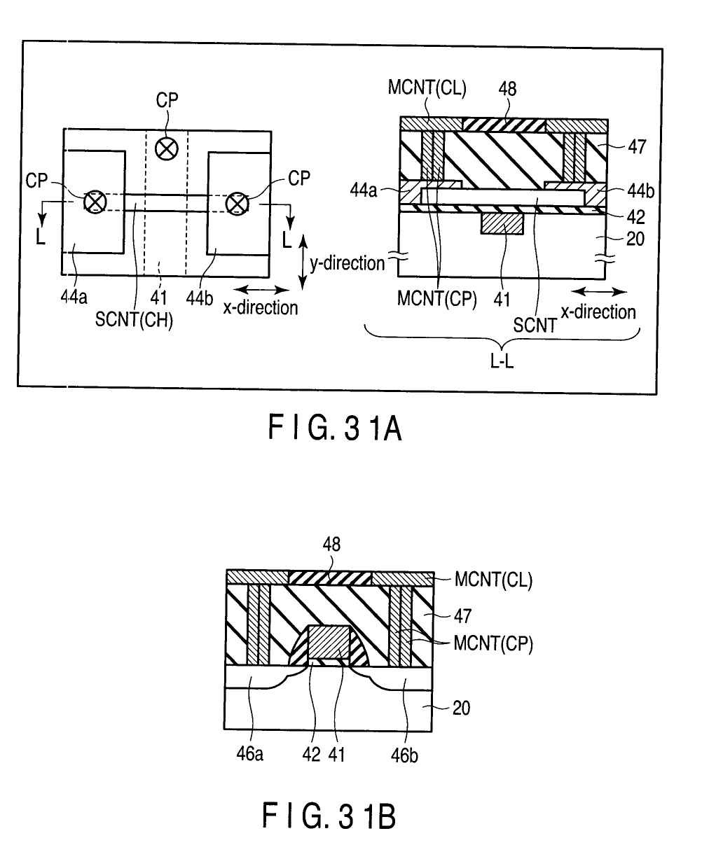

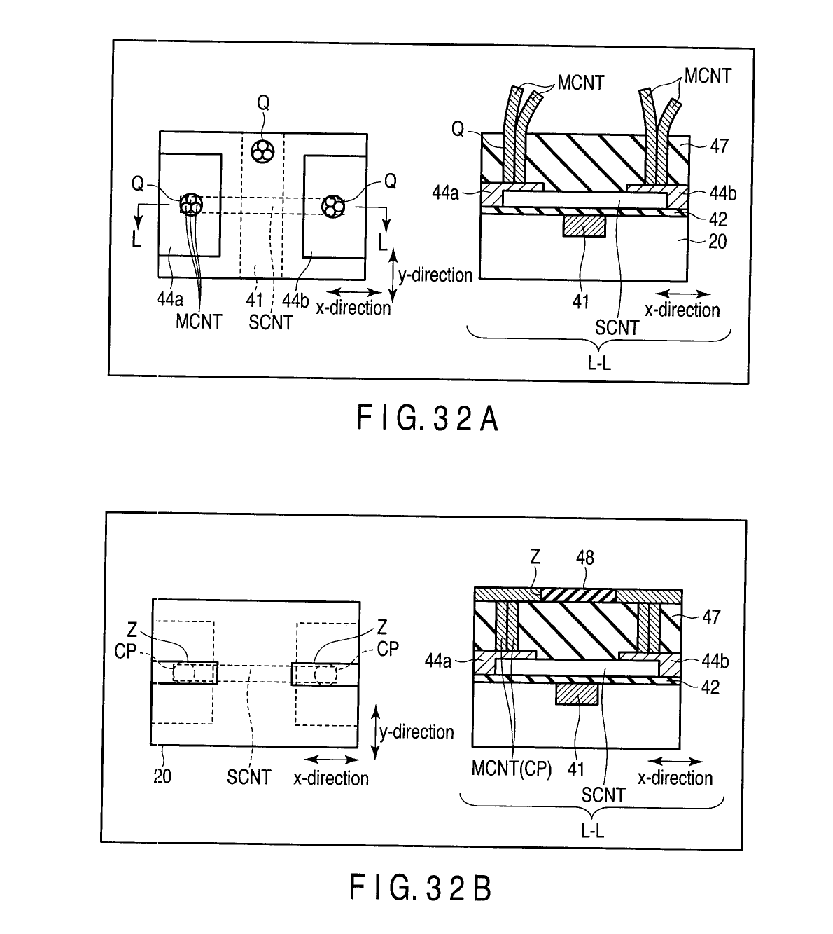

Applications of the metallic carbon nano tubes sorted out by the apparatus and method for sorting carbon nano tubes according to each of the first to sixth embodiments of the invention will be described with reference to FIGS. 31A and 31B and FIGS. 32A and 32B.

(a) Structure

Since the metallic carbon nano tube has a resistance lower than that of metal, such as aluminum or copper (high conductivity), it can be used for, for example, an interconnection of a semiconductor integrated circuit.

FIGS. 31A and 31B show the structures of a contact plug CP and an interconnection CL using the metallic carbon nano tubes MCNT. In the following description, the same components as those in the CNT transistor shown in FIG. 29 are denoted by the same reference numerals, and a detailed description thereof will not be repeated.

FIG. 31A shows a plan view illustrating the structure of the CNT transistor and a cross-sectional view taken along the line L-L (channel length direction). As shown in FIG. 31A, in the CNT transistor, the contact plugs CP using the metallic carbon nano tubes MCNT are embedded in the interlayer insulating film 47 so as to be connected to the source and drain electrodes 44a and 44b. For example, a bundle of a plurality of carbon nano tubes MCNT is used as the contact plug CP. The interconnection CL using the metallic carbon nano tubes are formed in the interlayer insulating film 48.

As shown in FIG. 31B, the metallic carbon nano tube MCNT may be applied to the contact plug CP or the interconnections CL of a field effect transistor (for example, a MOS transistor) using a semiconductor substrate as a channel region.

The MOS (metal-oxide-semiconductor) transistor shown in FIG. 31B includes two diffusion layers corresponding to a source and a drain (hereinafter, referred to as source and drain diffusion layers) 46a and 46b in a semiconductor substrate 20. A gate electrode 41 is provided on the channel region between the source and drain diffusion layers 44a and 44b, with a gate insulating film 42 interposed therebetween. Then, the metallic carbon nano tubes MCNT, serving as the contact plugs CP and the interconnections CL, are connected to the source and drain diffusion layers 46a and 46b.

FIGS. 31A and 31B show an example in which the metallic carbon nano tubes MCNT are used for the contact plugs CP and the interconnections CL connected to the source and drain electrodes 44a and 44b, and the source and drain diffusion layers 46a and 46b of the transistor. However, the metallic carbon nano tubes MCNT may be used for contacts (vias) or wiring lines that are provided above these layers by a multi-layer interconnection technique.

Since the semiconductor carbon nano tubes and the metallic carbon nano tubes are sorted out as described in the first to sixth embodiments, according to these applications, it is possible to form the contact plug CP and the interconnection CL with only the metallic carbon nano tubes MCNT. Therefore, since the carbon nano tubes having substantially the same characteristics (the same band gap) are used, it is possible to uniformize the electrical characteristics of the contacts and the interconnection CL characteristics.

As described above, it is possible to apply the metallic carbon nano tubes MCNT sorted out by the apparatus and method according to each of the first to sixth embodiments of the invention to the contact plugs CP or the interconnection CL.

(b) Manufacturing Method

A method of manufacturing the contact plug CP and the interconnection CL using the metallic carbon nano tubes MCNT will be described with reference to FIGS. 31A and 31B. The manufacturing processes shown in FIGS. 31A, 32A and 32B are subsequent to the manufacturing processes shown in FIGS. 29 to 30F.

FIGS. 32A and 32B are a plan view illustrating a process of the method of manufacturing forming the contact plugs and the interconnection CL after the CNT transistor is formed and a cross-sectional view taken along the line L-L (channel length direction).

As shown in FIG. 32A, after the interlayer insulating film 47 is formed so as to cover the CNT transistor, contact holes Q are formed in the interlayer insulating film 47. In this way, the surfaces of the source and drain electrodes 44a and 44b are exposed.

Then, the metallic carbon nano tubes MCNT sorted out by the apparatus and method according to each of the first to sixth embodiments of the invention are inserted into the formed contact holes Q. One or more metallic carbon nano tubes MCNT are inserted into each of the contact holes Q.

In this case, the inserted metallic carbon nano tube MCNT may protrude from the upper end of the contact hole Q. Therefore, similarly to the method described with reference to FIGS. 22A and 22B, CMP is performed on the metallic carbon nano tubes MCNT using the interlayer insulating film 47 as a stopper.

Then, as shown in FIG. 32B, the carbon nano tubes MCNT are polished such that the upper ends of the metallic carbon nano tubes MCNT, serving as the contact plugs CP, are substantially flush with the upper end of the interlayer insulating film 47.

Then, an interlayer insulating film 48 is deposited on the interlayer insulating film 47. The grooves Z are formed in the interlayer insulating film 48 such that a predetermined the interconnection layout is obtained. Then, for example, similarly to the method described with reference to FIG. 24, the metallic carbon nano tubes MCNT are arranged in the grooves Z. In this way, the arrangement of the metallic carbon nano tubes MCNT is controlled.

In this case, for example, the method described with reference to FIG. 27 may be used to fix the arrangement of the metallic carbon nano tubes MCNT serving as the interconnection CL. That is, the thiol groups or the inorganic material-bounded peptides are added to the ends of the metallic carbon nano tubes MCNT in advance, and a film (not shown) that is bound to the thiol group or the peptide, such as an Au film or an inorganic film) is formed at a predetermined position in the groove Z.

Then, the metallic carbon nano tubes MCNT are introduced on the interlayer insulating films 47 and 48, and the interconnection CL using the metallic carbon nano tubes MCNT are bound to the metal film or the inorganic film (not shown) formed in the groove Z. In this way, the interconnections are fixed at predetermined positions.

In this case, the carbon nano tubes are electrically connected to each other by the metal film or the conductive inorganic film. Therefore, it is possible to prevent the electrical characteristics of the interconnection CL from deteriorating due to a contact error between the metallic carbon nano tubes MCNT.

In this way, the contact plug CP and the interconnection CL using the metallic carbon nano tubes MCNT are completed.

As described above, the metallic carbon nano tubes are sorted out by the apparatus and method for sorting carbon nano tubes according to each of the first to sixth embodiments of the invention. Then, the sorted out metallic carbon nano tubes are used to manufacture the contact plugs and the interconnection CL by the manufacturing method shown in FIGS. 31A and 31B.

(4) Emitter Element

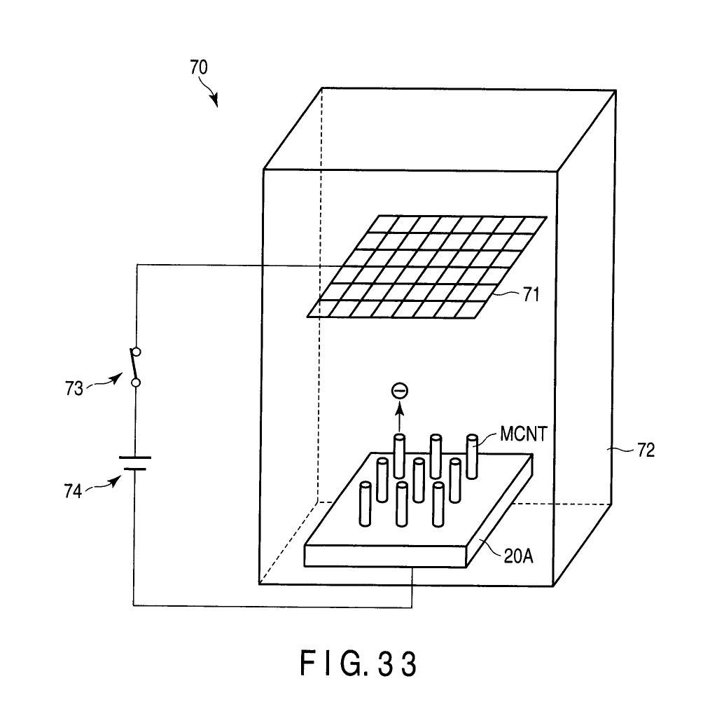

An example in which the metallic carbon nano tube MCNT sorted out by the above-described embodiments of the invention is applied to, for example, an electron emission source (emitter element), for a display, for example, will be described with reference to FIG. 33. Hereinafter, an emitter element using the carbon nano tube is referred to as a CNT emitter element.

FIG. 33 shows a multi-emitter 70 to which the metallic carbon nano tube is applied.

The multi-emitter 70 includes a cathode electrode 20A and a mesh-shaped anode electrode 71 in a vacuum case 72. A power supply 74 is connected to the anode electrode 71 and the cathode electrode 20A through a switch 73.

A phosphor (not shown) is provided on one surface of the anode electrode 71 facing the cathode electrode 20A.

A plurality of CNT emitter elements MCNT are provided on the cathode electrode 20A. The plurality of CNT emitter elements are, for example, the metallic carbon nano tubes MCNT.

For example, the plurality of metallic carbon nano tubes MCNT shown in FIG. 33 are formed so as to be grown in a porous layer in a direction vertical to the surface of the substrate 20A. Then, the metal carbon nano tubes MCNT are selectively left on the substrate 20A by the sorting method according to the third embodiment.

In this case, when the metallic carbon nano tubes MCNT used for the CNT emitter elements are formed by using the porous layer, the metallic carbon nano tubes MCNT are arranged in a matrix on the substrate 20A. Therefore, it is not necessary to rearrange the metallic carbon nano tubes MCNT serving as the emitter elements. When the carbon nano tubes are formed and sorted as in the third embodiment, it is possible to simplify a process of manufacturing the CNT emitter elements MCNT and the multi-emitter 70.

One end (leading end) of each of the CNT emitter elements MCNT faces the anode electrode 71. Therefore, since electrons are emitted from the sharp ends of the metallic carbon nano tubes MCNT, it is possible to reduce a driving voltage for emitting the electrons.

It is preferable that the substrate 20A serve as a cathode, and a substrate made of a conductive material, such as metal or a semiconductor is used as the substrate 20A. Alternatively, an insulating substrate having a conductive film on the surface thereof may be used. FIG. 33 shows an example in which the porous layer is removed from the substrate 20A (cathode electrode). However, the porous layer may remain on the substrate 20A. In addition, a grid electrode may be provided on the remaining porous layer so as to be adjacent to the leading end of the metallic carbon nano tube MCNT serving as the emitter element. The emission of electrons from the emitter element can be controlled by the grid electrode.

In order to uniformize the characteristics of the emitter element, it is preferable that CMP be performed on the leading ends of the carbon nano tubes such that the lengths of the carbon nano tubes are equal to each other, as described with reference to FIG. 22.

It is appreciated that the metallic carbon nano tubes sorted out according to the first and second embodiments may be dispersed on the substrate 20A to be applied to the CNT emitter elements.

As described above, the carbon nano tubes are sorted according to their characteristics by the apparatus and method according to each of the first to sixth embodiments of the invention. Then, the sorted out metallic carbon nano tubes MCNT can be applied to the emitter elements.

[Other]

In the above-described embodiments of the invention, a method of sorting a plurality of carbon nano tubes according to their magnetic characteristics and properties has been described. However, the invention is not limited to the carbon nano tubes.

When there is a difference in magnetic (paramagnetic/diamagnetic) characteristics between the microscopic (for example, nano-level) structures (products), particularly, structures made of six-membered ring formed on the same substrate under the same conditions, the invention may be applied to the microscopic structures. That is, it is possible to use the difference between the magnetic characteristics of the structures to sort a plurality of structures according to their properties and characteristics. Therefore, it is possible to obtain the same effects as those in the above-described embodiments of the invention from microscopic structures other than the carbon nano tubes.

The invention is not limited to the above-described embodiments, and components of the invention can be changed without departing from the scope and spirit of the invention. In addition, a plurality of components according to the above-described embodiments may be appropriately combined with each other to form various structures. For example, some of all the embodiments according to the above-described embodiments may be removed, and components according to different embodiments may be appropriately combined with one another.

What is claimed is:

1. An apparatus for manufacturing carbon nano tubes, comprising:
an introducing unit commonly introducing a first carbon nano tube having first magnetic characteristics and a second carbon nano tube having second magnetic characteristics different from the first magnetic characteristics;
first and second collecting units collecting the first and second carbon nano tubes, respectively;
a transport unit transporting the first and second carbon nano tubes from the introducing unit to the first and second collecting units; and
at least one of a magnetic field generating unit which is provided adjacent to the transport unit and applies a magnetic field to the first and second carbon nano tubes;
wherein the first carbon nano tube and the second carbon nano tube are sorted by the magnetic field generating unit.

2. The apparatus for manufacturing carbon nano tubes according to claim 1, further comprising:
an exciting unit applying external energy to the first carbon nano tube and a third carbon nano tube having the first magnetic characteristics and having a band gap different from a band gap of the first carbon nano tube.

3. The apparatus for manufacturing carbon nano tubes according to claim 2,
wherein the external energy applied by the exciting unit is smaller than the band gap energy of the first carbon nano tube and equal to or larger than the band gap energy of the third carbon nano tube,
the third carbon nano tube is excited by the external energy such that the magnetic characteristics of the third carbon nano tube are changed from the first magnetic characteristics to the second magnetic characteristics, and
the first carbon nano tube and the third carbon nano tube are sorted out by the magnetic field generating unit.

4. The apparatus for manufacturing carbon nano tubes according to claim 2,
wherein the exciting unit includes at least one of a laser oscillator and a heating device.

5. The apparatus for manufacturing carbon nano tubes according to claim 1, further comprising:
a vibrating unit which is provided adjacent to the transport unit and applies vibration to the first carbon nano tube and the second carbon nano tube.

6. The apparatus for manufacturing carbon nano tubes according to claim 1,
wherein the first carbon nano tube and the second carbon nano tube fall in the transport unit having a liquid or a gas sealed therein.

7. The apparatus for manufacturing carbon nano tubes according to claim 2,
wherein a plurality of magnetic field generating unit are provided,
after the first and third carbon nano tube is sorted form the second carbon nano tube by one magnetic field generating unit,
the first carbon nano tube is sorted form the third carbon nano tube by other magnetic field generating unit.

8. A method of sorting carbon nano tubes, comprising:
commonly introducing a first carbon nano tube having first magnetic characteristics and a second carbon nano tube having second magnetic characteristics;
applying a magnetic field to the first and second carbon nano tubes to sort out the first carbon nano tube and the second carbon nano tube using interaction between the first magnetic characteristics and the magnetic field; and
collecting the sorted out first and second carbon nano tubes into different collecting units.

9. The method of sorting carbon nano tubes according to claim 8, further comprising:
introducing a third carbon nano tube having the first magnetic characteristics and having a band gap different from a band gap of the first carbon nano tube and the first and second carbon nano tubes at the same time;
exciting the third carbon nano tube with external energy that is smaller than the band gap energy of the first carbon nano tube and is equal to or larger than the band gap energy of the third carbon nano tube such that the magnetic characteristics of the third carbon nano tube are changed from the first magnetic characteristics to the second magnetic characteristics; and
sorting out the first carbon nano tube and the third carbon nano tube using the interaction between the first magnetic characteristics and the magnetic field.

10. The method of sorting carbon nano tubes according to claim 8, further comprising:
dispersing the sorted out carbon nano tubes in a liquid; and
flowing the liquid on a substrate having a plurality of pillars, and arranging the carbon nano tubes in a direction in which the pillars are arranged.

11. The method of sorting carbon nano tubes according to claim 8, further comprising:
dispersing the sorted out carbon nano tubes in a liquid; and
flowing the liquid on a substrate having grooves, and arranging the carbon nano tubes in the grooves.

12. The method of sorting carbon nano tubes according to claim 8, further comprising:
adding at least one of atoms having magnetism, molecules having magnetism, and chelates having magnetism to ends of the sorted out carbon nano tubes;
dispersing the added carbon nano tubes on a substrate; and
applying a magnetic field to the substrate to arrange the carbon nano tubes dispersed on the substrate in the direction of the magnetic field.

13. The method of sorting carbon nano tubes according to claim 8, further comprising:
adding sulfur or molecules including sulfur to ends of the sorted out carbon nano tubes;
dispersing the added carbon nano tubes in a liquid; and
flowing the liquid on a substrate including a region having metal, and arranging the added carbon nano tubes in the region having the metal provided therein.

14. The method of sorting carbon nano tubes according to claim 8, further comprising:
adding peptides bound to an inorganic material to ends of the sorted out carbon nano tubes;
dispersing the carbon nano tubes having the peptides added thereto in a liquid; and
flowing the liquid on a substrate including a region having the inorganic material, and arranging the carbon nano tubes having the peptides added thereto in the region having the inorganic material provided therein.

15. The method of sorting carbon nano tubes according to claim 9,
wherein the external energy is at least one of light energy and thermal energy.

16. The method of sorting carbon nano tubes according to claim 8,
wherein the first magnetic characteristics are diamagnetic characteristics, and the second magnetic characteristics are paramagnetic characteristics.

17. A method of sorting carbon nano tubes, comprising:
forming a first carbon nano tube having first magnetic characteristics and a second carbon nano tube having second magnetic characteristics on one substrate; and
applying a magnetic field to the first and second carbon nano tubes such that the first carbon nano tube is selectively separated from the substrate and the second carbon nano tube remains on the substrate by interaction between the magnetic field and the first magnetic characteristics.

18. The method of sorting carbon nano tubes according to claim 17,
wherein the substrate has a porous layer formed thereon, and
the first and second carbon nano tubes are formed in pores of the porous layer.

19. The method of sorting carbon nano tubes according to claim 18, further comprising:
removing portions of the carbon nano tubes that protrude from upper ends of the pores using a CMP method.
